(19) United States
(12) Patent Application Publication
(10) Pub. No.: US 2026/0161544 A1
(43) Pub. Date: Jun. 11, 2026

(54) Dynamic Capacity Devices Implemented via Dynamic Mapping of Memory addresses in Memory Access Requests Routed Through a Compute Express Link Fabric

(71) Applicant: Micron Technology, Inc., Boise, ID (US)

(72) Inventors: Kamil Khan, Folsom, CA (US); Poorna Kale, Folsom, CA (US)

(21) Appl. No.: 18/977,742

(22) Filed: Dec. 11, 2024

(51) Int. Cl. G06F 12/02

(52) U.S. Cl. CPC G06F 12/023

(57) ABSTRACT

A system having a compute express link fabric having a controller, memory devices connected to the fabric, and a host processor connected to the fabric. The controller can: attach, at a boot time of the system, a logical memory device to the host processor; allocate memory resources from the memory devices to implement the logical memory device using a mapping between memory addresses in the logical memory device and the memory resources to route memory access requests having the memory addresses to access the memory resources in the memory devices; and receive a request from the host processor to change a capacity size of the logical memory device attached to the host processor and, in response to the request, adjust the mapping to change the capacity size of the logical memory device without restarting the system, the host processor, and/or the fabric.

### TECHNICAL FIELD

At least some embodiments disclosed herein relate to memory systems in general and, more particularly but not limited to, memory accessed via compute express link connections.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The embodiments are illustrated by way of example and not limitation in the figures of the accompanying drawings in which like references indicate similar elements.

FIG. 1 illustrates an example computing system having a host system and a memory sub-system configured in accordance with some embodiments of the present disclosure.

FIG. 2 to FIG. 4 show techniques to provide a secondary tier memory according to some embodiments.

FIG. 5 shows a compute express link fabric configured to provide a secondary tier memory according to one embodiment.

FIG. 6 shows the attaching of dynamic capacity devices over a compute express link fabric to provide a random access memory according to one embodiment.

FIG. 7 shows a technique to dynamically adjust the performance level of a random access memory of a host system according to one embodiment.

FIG. 8 illustrates a technique to determine capacity allocations for dynamic capacity devices to implement a random access memory having a performance target according to one embodiment.

FIG. 9 shows a mapped memory space implemented via a compute express link fabric to provide a dynamically adjustable random access memory according to one embodiment.

FIG. 10 shows a compute express link switch configured to implement a dynamically adjustable random access memory according to one embodiment.

FIG. 11 shows a technique to implement a portion of a random access memory using a memory sub-system connected to a compute express link fabric according to one embodiment.

FIG. 12 illustrates a controller of a compute express link (CXL) fabric caching portions of memory sub-systems in the memory space provided by memory devices connected to the fabric according to one embodiment.

FIG. 13 illustrates communications to implement a memory access request according to one embodiment.

FIG. 14 shows a technique to implement a logical memory device attached to a host processor over a compute express link fabric according to one embodiment.

FIG. 15 shows communications of a host processor to dynamically change aspects of a logical memory device according to one embodiment.

FIG. 16 shows a technique to dynamically change the capacity size of a logical memory device according to one embodiment.

FIG. 17 and FIG. 18 show techniques to dynamically change the bandwidth of a logical memory device in servicing a host processor over express link connections according to one embodiment.

FIG. 19 to FIG. 21 show techniques to dynamically change the latency of a logical memory device in servicing a host processor over express link connections according to one embodiment.

FIG. 22 and FIG. 23 show techniques to dynamically change the power consumption level of a logical memory device in servicing a host processor over express link connections according to one embodiment.

FIG. 24 shows a method to implement a dynamically adjustable secondary tier memory attached via compute express link connections to a host processor according to one embodiment.

FIG. 25 shows a method to dynamically change the capacity size of a random access memory in a secondary tier memory of a host processor according to one embodiment.

FIG. 26 shows a method to dynamically change the performance level in bandwidth of a random access memory in a secondary tier memory of a host processor according to one embodiment.

FIG. 27 shows a method to dynamically change the performance level in latency of a random access memory in a secondary tier memory of a host processor according to one embodiment.

FIG. 28 shows a method to dynamically change the performance level in power consumption of a random access memory in a secondary tier memory of a host processor according to one embodiment.

FIG. 29 is a block diagram of an example computer system in which embodiments of the present disclosure can operate.

### DETAILED DESCRIPTION

Different workloads can have different demands on memory resources. Without explicit information about workloads, memory resources in a computing system can be inadequately configured, causing over-provisioning in some aspects and/or under-provisioning in other aspects.

At least some aspects of the present disclosure address the above and other deficiencies and challenges by implementing a random access memory via a compute express link (CXL) fabric to a host processor, where at least some aspects (e.g., capacity, bandwidth, latency, power consumption level) of the random access memory can be defined and/or adjusted via software running in the host processor.

Dynamic capacity devices (DCDs) are logical memory devices supported by a standard of compute express link (CXL), where the capacity of a dynamic capacity device attached via compute express link (CXL) to a host system can be adjusted or changed without restarting the host system and/or without restarting the computing system containing the host system and the memory device.

In at least some embodiments disclosed herein, a host system can dynamically request changes in characteristics/attributes of the random access memory attached to the host system via CXL connections without restarting. Such characteristics/attributes can include capacity, bandwidth, latency, or power consumption level, or any combination thereof.

For example, the random access memory of a host processor can be implemented via a set of dynamic capacity devices offered by a plurality of memory devices of different characteristics, such as bandwidth, latency, power consumption level, etc. The dynamic capacity devices are attached to the host processor at the time of booting up the computing system containing the host processor and the memory devices. The capacity sizes of the dynamic capacity devices can be adjusted at the run time of the host processor without restarting.

By requesting the memory devices to change the capacity sizes of the dynamic capacity devices, the host processor can dynamically change the ratio of memory resources allocated from the memory devices of different characteristics to implement the random access memory of the host processor. Changing the memory resource allocation ratio can change the characteristics/attributes of the random access memory attached to the host processor.

For example, the host processor can determine the desirable characteristics/attributes of the random access memory based on the requirements or demands of the applications running in the host processor. The host processor can request changes in the capacity sizes of the dynamic capacity devices in a way such that the random access memory has characteristics/attributes that meet the requirements or demands of the applications.

Dynamic capacity devices offered by memory devices connected to a CXL fabric have performance levels of the respective memory devices in servicing a host processor over the fabric. For example, due to the connection topology and/or the differences in the memory devices as manufactured, the memory devices can have different performance levels in bandwidth, latency, and/or power consumption in servicing the host processor over the CXL fabric. Changing the distribution of capacity sizes across the dynamic capacity devices attached to the host processor can change various aspects (e.g., capacity, bandwidth, latency, power consumption level) of the random access memory implemented using the dynamic capacity devices.

In some implementations, the CXL fabric is configured to allocate memory resources from memory devices connected to the CXL fabric to implement logical memory devices attached to host processors. For example, the logical memory devices can be offered by the CXL fabric in a form of dynamic capacity devices that are attached to the host processors during the boot up time. The CXL fabric can dynamically change the mapping of memory addresses in the logical memory devices to the memory resources allocated from the memory devices to change the aspects (e.g., capacity, bandwidth, latency, power consumption level) of the local memory devices offered by the CXL fabric to the host processors.

In general, a set of compute express link (CXL) connections, a CXL switch, and/or a CXL fabric containing one or more CXL switches interconnected by CXL connections can be used to connect a plurality of memory devices to one or more host processors, such as a central processing unit (CPU), a graphical processing unit (GPU), a system on a chip (SoC), an artificial intelligence (AI) accelerator, etc. Each of the memory devices and/or a controller of the CXL fabric can offer a plurality of dynamic capacity devices. Each of the dynamic capacity devices can be attached to a host processor such that the host processor has a secondary tier of memory that is dynamically adjustable in various aspects, such as capacity, bandwidth, latency, power efficiency, etc.

A plurality of dynamic capacity devices can be attached to a host processor during the boot time of the computing system. The dynamic capacity devices provide a secondary tier memory for the host processor. The host processor can adjust the nominal performance levels of the secondary tier memory in capacity, bandwidth, latency, power efficiency, etc. by requesting changes in the capacity sizes of the dynamic capacity devices. When a dynamic capacity device is offered by the controller of the CXL fabric, the host processor can request the controller to implement the dynamic capacity device according to a performance level specified by the host processor. The plurality of dynamic capacity devices as a whole can provide the secondary tier memory to supplement the primary tier memory of the host processor (e.g., the main memory connected to the host processor via a memory bus, such as a double data rate bus).

Due to the differences in the memory devices and/or their locations in the network of CXL connections from the memory devices to the host processor, the plurality of dynamic capacity devices offered by the memory devices can have different performance levels in bandwidth, latency, and/or power consumption. The host processor can determine a combination of capacity sizes of the dynamic capacity devices such that the secondary tier memory has performance levels in capacity, bandwidth, latency, and/or power consumption that meet, or approximately match with (e.g., in average over time), a memory configuration requirement identified by the host processor for the applications running in the host processor.

Other dynamic capacity devices can be attached over the CXL connections, switch and/or fabric to one or more other host processors to service their applications.

Since the capacity of each dynamic capacity device attached to a host processor can be changed dynamically without restarting, and the characteristics of logical memory devices implemented by the controller of the CXL fabric can change without restarting, a software component running in the host processor can determine and adjust the ratio of capacity distribution across the dynamic capacity devices that are attached to the host processor, such that the average performance level of the random access memory, implemented as the secondary tier memory using the dynamic capacity devices, matches with or satisfies a memory performance target of one or more applications currently running in the host processor.

By tweaking the distribution of capacity sizes across the dynamic capacity devices attached to a host processor, the host processor can effectively allocate, over a CXL switch or fabric, a random access memory having a target performance level needed for the applications currently running in the host processor. The random access memory can have a capacity, bandwidth, latency, and/or power consumption level defined or requested by a software component (e.g., an operating system or a hypervisor) running in the host processor. Customization of characteristics of the random access memory used by the host processor over the CXL switch or fabric as a secondary tier memory can be performed on-demand and at a runtime of applications without hardware changes.

The memory resources connected to the CXL switch or fabric but not used by the host processor can be allocated and used by one or more other host processors connected to the CXL switch or fabric. Different host processors can have their respective secondary tier memory of different characteristics (e.g., capacity, bandwidth, latency, and/or power consumption), implemented using different portions of the same set of physical memory devices connected to the CXL switch or fabric.

For example, a software component (e.g., an operating system or a hypervisor) running in the host processor can define the capacity of the secondary tier memory (e.g., the total amount of data that can be stored in the secondary tier memory). When the applications running in the host processor needs more memory, the software component can request one or more of the dynamic capacity devices attached to the host processor to increase capacity; and when the applications running in the host processor finishes using the memory, the software component can return the excessive memory by requesting the one or more dynamic capacity devices to decrease capacity.

For example, a software component (e.g., an operating system or a hypervisor) running in the host processor can identify the bandwidth of the secondary tier memory (e.g., the rate at which the secondary tier memory can read or write data) to support the applications running in the host processor. Depending on the topology of the CXL network and the location of the dynamic capacity devices, different memory regions on the CXL network can be accessed by the host processor with different memory bandwidth levels, even when each memory device has a same memory bandwidth when the memory device is used in a direct connection. The availability of communication bandwidths in the CXL network and/or real time communication traffic pattern in the CXL network can limit the memory bandwidth of a memory device in serving the host processor. For example, a dynamic capacity device can be attached directly to a host through one or more CXL/PCI lanes for an increased bandwidth, or through one or more CXL switches over a network of CXL connections shared by different host processors and/or memory devices for a reduced bandwidth. Depending on application requirements, the software component running in the host processor can decide how to make capacity adjustments to the dynamic capacity devices to meet a memory bandwidth requirement (or an average memory bandwidth target).

For example, a component running in the host processor can identify the latency of the secondary tier memory (e.g., the delay between a memory request sent from a processor and a response received in the processor in response to the request) to support the applications running in the host processor. The latency of a dynamic capacity device connected via one or more compute express link (CXL) connections (e.g., connected directly or through one or more CXL switches) can be dependent on the overhead in communications over the CXL connections, runtime sharing of CXL connections, communications traffic conditions, and the latency of the memory device responding to a request. The software component running in the host processor can select capacity adjustment requests for the dynamic capacity devices attached to the host processor such that the secondary tier memory meets a latency requirement (or an average memory latency), in view of the various factors that can impact the latency of the secondary tier memory.

For example, a software component running in the host processor can identify a desirable power consumption level of the secondary tier memory for the secondary tier memory. Different dynamic capacity devices can have different power profiles. Depending on the cost goals of a computing system and/or applications, the software can power-down power-hungry memory devices connected to the CXL fabric to reduce memory power consumption, and utilize power-efficient memory devices at an acceptable level of performance degradation.

A software layer can be configured to implement tiering management across kernel-space and/or user-space. The software layer can manage (e.g., based on memory access patterns) the placement and movement of memory pages in and among the primary tier memory (e.g., the main memory provided over a memory bus, such as a double data rate (DDR) memory bus) and the secondary tier memory (e.g., memory devices connected over one or more compute express link connections over one or more peripheral component interconnect express (PCIe) buses). The operations of the software layer running in the host processor to move memory pages can significantly degrade the application performance due to the active demotion of cold memory pages to the slower memory, and subsequent accesses to cold memory pages. A memory page that has not been accessed for a period of time can be considered a cold memory page; and the length of a continuous time period in which a memory page has not being access can be an indicator of a temperature of the memory page; a longer length corresponding to a colder page.

Tiering management can be implemented via hardware in the memory system, instead of via a host processor running a software layer. When tiering management is implemented solely in memory hardware, the configuration of the tiered memory cannot be changed without significant changes at different levels in the hardware and software stack.

In general, the bandwidth of a random access memory provided over one or more compute express link (CXL) connections to a host processor can be dependent on several factors: the number of parallel CXL paths between the random access memory and the host processor, the switching topology of a CXL fabric coupled between the random access memory and the host processor, the efficiency of each CXL switch in the CXL fabric, real time traffic load in the CXL fabric, the latency of the memory media, etc.

In some embodiments disclosed herein, a software technique is used to allocate the memory bandwidth required for applications during runtime.

For example, a fabric manager can be configured as a software component running in a CXL fabric (e.g., in a controller of the CXL fabric, or as a set of agents running in the CXL switches of the fabric). A host processor (e.g., a central processing unit (CPU), a graphical processing unit (GPU), a system on a chip (SoC)) connected to the CXL fabric can specify a memory configuration requirement for a random access memory attached via the CXL fabric to the host processor. For example, the memory configuration requirement can specify a requested capacity, a requested bandwidth, and/or a requested latency of the random access memory. The fabric manager can allocate communication resources of the CXL fabric and memory resources of memory devices connected to the CXL fabric to implement a random access memory that has an implemented memory configuration that is closest to the requested memory configuration.

For example, the distance between the implemented memory configuration and the requested memory configuration can be based on a cartesian distance in a memory characteristic space having independent axes in capacity, latency, bandwidth, and/or power efficiency. A requested memory configuration is represented by a point in the memory characteristics space having coordinates represented by the requested capacity, latency, bandwidth, and/or power efficiency. An implemented memory configuration is represented by a point in the memory characteristics space having coordinates represented by the implemented capacity, latency, bandwidth, and/or power efficiency. The cartesian distance between the two points in the memory characteristic space can be minimized or reduced to find an implementation that substantially meet the requirements of the requested memory configuration.

In some implementations, the memory characteristic space is configured based on normalized memory parameters, such as normalized capacity, normalized latency, normalized bandwidth, and/or normalized power efficiency level. For example, the memory characteristic parameters (e.g., capacity, latency, bandwidth, power efficiency level) can be normalized with respect to the corresponding parameters specified in the memory configuration request, or normalized using a set of predetermined parameters (e.g., reference capacity, reference latency, reference bandwidth, reference power efficiency level). Optionally, the normalized parameters can be further weighted according to importance of the respective parameters (e.g., capacity, latency, bandwidth, power efficiency) for the applications running in the host processor.

In some implementations, the fabric manager is configured with a look up table to map the memory addresses identified by the host processor in memory access requests to physical memory addresses of random access memory cells in memory devices connected to the CXL fabric. Through the mapping implemented using the look up table, the memory access requests received in the CXL fabric from the processor can be routed via the CXL fabric to the corresponding memory devices from which the memory resources are allocated to implement the secondary tier random access memory attached to the host processor via the CXL fabric.

Optionally, the fabric manager can continuously or periodically update the look up table used to implement the random access memory attached to the processor to account for runtime variation in memory characteristics such as bandwidth and latency. Optionally, the fabric manager can monitor the deviation of the memory characteristics (e.g., bandwidth, latency) from the requirements specified by the host processor, and update the look up table to reduce or eliminate the differences from the requirements in response to a determination that the deviation exceeds a predefined threshold.

In one implementation, during an initialization phase of attaching the secondary tier memory to a host processor for random access over a CXL fabric, each of the memory devices connected to the CXL fabric can have a small portion of its entire capacity allocated to implement the secondary tier memory. The host processor can run a synthetic workload to determine the observed characterizes (e.g., bandwidth, latency) of each memory allocation. Each memory device connected to the CXL fabric can identify its size of entire capacity to the fabric manager. During the runtime phase of the processor using the random access memory, the memory devices connected to the CXL fabric can send metadata to the fabric manager to indicate the observed latency to the host processor. Based on the measured latency and bandwidth, the fabric manager can adjust the portion sizes of memory resource allocation from the memory devices to implement the random access memory in a way that meets the memory configuration requirement identified the processor and/or reduce the differences between the memory configuration as implemented via the CXL fabric and the memory configuration as requested by the host processor.

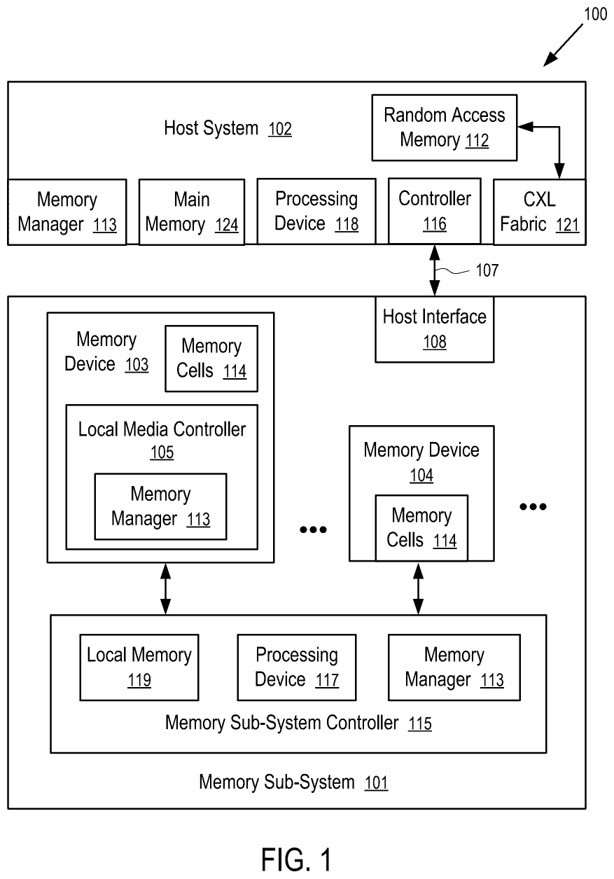

FIG. 1 illustrates an example computing system 100 that includes a memory sub-system 101 in accordance with some embodiments of the present disclosure. The memory sub-system 101 can include media, such as one or more volatile memory devices (e.g., memory device 104), one or more non-volatile memory devices (e.g., memory device 103), or a combination of such.

In general, a memory sub-system 101 can be a storage device, a memory module, or a hybrid of a storage device and memory module. Examples of a storage device include a solid-state drive (SSD), a flash drive, a universal serial bus (USB) flash drive, an embedded multi-media controller (eMMC) drive, a universal flash storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory module (NVDIMM).

The computing system 100 can be a computing device such as a desktop computer, a laptop computer, a network server, a mobile device, a vehicle (e.g., airplane, drone, train, automobile, or other conveyance), an internet of things (IoT) enabled device, an embedded computer (e.g., one included in a vehicle, industrial equipment, or a networked commercial device), or such a computing device that includes memory and a processing device.

The computing system 100 can include a host system 102 that is coupled to one or more memory sub-systems 101. FIG. 1 illustrates one example of a host system 102 coupled to one memory sub-system 101. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

For example, the host system 102 can include a processor chipset (e.g., processing device 118) and a software stack executed by the processor chipset. The processor chipset can include one or more cores, one or more caches, a memory controller (e.g., controller 116) (e.g., NVDIMM controller), and a storage protocol controller (e.g., PCIe controller, SATA controller). The host system 102 uses the memory sub-system 101, for example, to write data to the memory sub-system 101 and read data from the memory sub-system 101.

The host system 102 can be coupled (e.g., over a computer bus 107) to the memory sub-system 101 via a physical host interface 108. Examples of a physical host interface 108 include, but are not limited to, a serial advanced technology attachment (SATA) interface, a peripheral component interconnect express (PCIe) interface, a universal serial bus (USB) interface, a fibre channel, a serial attached SCSI (SAS) interface, a double data rate (DDR) memory bus interface, a small computer system interface (SCSI), a dual in-line memory module (DIMM) interface (e.g., DIMM socket interface that supports double data rate (DDR)), an open NAND flash interface (ONFI), a double data rate (DDR) interface, a low power double data rate (LPDDR) interface, a compute express link (CXL) interface, or any other interface. The physical host interface 108 can be used to transmit data between the host system 102 and the memory sub-system 101. The host system 102 can further utilize an NVM express (NVMe) interface to access components (e.g., memory devices 103) when the memory sub-system 101 is coupled with the host system 102 by the PCIe interface. The physical host interface 108 can provide an interface for passing control, address, data, and other signals between the memory sub-system 101 and the host system 102. FIG. 1 illustrates a memory sub-system 101 as an example. In general, the host system 102 can access multiple memory sub-systems via a same communication connection, multiple separate communication connections, and/or a combination of communication connections.

The processing device 118 of the host system 102 can be, for example, a microprocessor, a central processing unit (CPU), a processing core of a processor, an execution unit, etc. In some instances, the controller 116 can be referred to as a memory controller, a memory management unit, and/or an initiator. In one example, the controller 116 controls the communications over a bus coupled between the host system 102 and the memory sub-system 101. In general, the controller 116 can send commands or requests to the memory sub-system 101 for desired access to memory devices 103, 104. The controller 116 can further include interface circuitry to communicate with the memory sub-system 101. The interface circuitry can convert responses received from the memory sub-system 101 into information for the host system 102.

The controller 116 of the host system 102 can communicate with the controller 115 of the memory sub-system 101 to perform operations such as reading data, writing data, or erasing data at the memory devices 103, 104 and other such operations. In some instances, the controller 116 is integrated within the same package of the processing device 118. In other instances, the controller 116 is separate from the package of the processing device 118. The controller 116 and/or the processing device 118 can include hardware such as one or more integrated circuits (ICs) and/or discrete components, a buffer memory, a cache memory, or a combination thereof. The controller 116 and/or the processing device 118 can be a microcontroller, special purpose logic circuitry (e.g., a field programmable gate array (FPGA), an application specific integrated circuit (ASIC), etc.), or another suitable processor.

The memory devices 103, 104 can include any combination of the different types of non-volatile memory components and/or volatile memory components. The volatile memory devices (e.g., memory device 104) can be, but are not limited to, random access memory (RAM), such as dynamic random access memory (DRAM) and synchronous dynamic random access memory (SDRAM).

Some examples of non-volatile memory components include a negative-and (or, NOT AND) (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 103 can include one or more arrays of memory cells 114. One type of memory cells, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 103 can include one or more arrays of memory cells such as SLCs, MLCs, TLCs, QLCs, PLCs, or any combination of such. In some embodiments, a particular memory device can include an SLC portion, an MLC portion, a TLC portion, a QLC portion, and/or a PLC portion of memory cells. The memory cells 114 of the memory devices 103 can be grouped as pages that can refer to a logical unit of the memory device used to store data. With some types of memory (e.g., NAND), pages can be grouped to form blocks.

Although non-volatile memory devices such as 3D cross-point type and NAND type memory (e.g., 2D NAND, 3D NAND) are described, the memory device 103 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), spin transfer torque (STT)-MRAM, conductive bridging RAM (CBRAM), resistive random access memory (RRAM), oxide based RRAM (OxRAM), negative-or (NOR) flash memory, and electrically erasable programmable read-only memory (EEPROM).

A memory sub-system controller 115 (or controller 115 for simplicity) can communicate with the memory devices 103 to perform operations such as reading data, writing data, or erasing data at the memory devices 103 and other such operations (e.g., in response to commands scheduled on a command bus by controller 116). The controller 115 can include hardware such as one or more integrated circuits (ICs) and/or discrete components, a buffer memory, or a combination thereof. The hardware can include digital circuitry with dedicated (i.e., hard-coded) logic to perform the operations described herein. The controller 115 can be a microcontroller, special purpose logic circuitry (e.g., a field programmable gate array (FPGA), an application specific integrated circuit (ASIC), etc.), or another suitable processor.

The controller 115 can include a processing device 117 (processor) configured to execute instructions stored in a local memory 119. In the illustrated example, the local memory 119 of the controller 115 includes an embedded memory configured to store instructions for performing various processes, operations, logic flows, and routines that control operation of the memory sub-system 101, including handling communications between the memory sub-system 101 and the host system 102.

In some embodiments, the local memory 119 can include memory registers storing memory pointers, fetched data, etc. The local memory 119 can also include read-only memory (ROM) for storing micro-code. While the example memory sub-system 101 in FIG. 1 has been illustrated as including the controller 115, in another embodiment of the present disclosure, a memory sub-system 101 does not include a controller 115, and can instead rely upon external control (e.g., provided by an external host, or by a processor or controller separate from the memory sub-system).

In general, the controller 115 can receive commands or operations from the host system 102 and can convert the commands or operations into instructions or appropriate commands to achieve the desired access to the memory devices 103. The controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory devices 103. The controller 115 can further include host interface circuitry to communicate with the host system 102 via the physical host interface 108. The host interface circuitry can convert the commands received from the host system into command instructions to access the memory devices 103 as well as convert responses associated with the memory devices 103 into information for the host system 102.

The memory sub-system 101 can also include additional circuitry or components that are not illustrated. In some embodiments, the memory sub-system 101 can include a cache or buffer (e.g., DRAM) and address circuitry (e.g., a row decoder and a column decoder) that can receive an address from the controller 115 and decode the address to access the memory devices 103.

In some embodiments, the memory devices 103 include local media controllers 105 that operate in conjunction with the memory sub-system controller 115 to execute operations on one or more memory cells of the memory devices 103. An external controller (e.g., memory sub-system controller 115) can externally manage the memory device 103 (e.g., perform media management operations on the memory device 103). In some embodiments, a memory device 103 is a managed memory device, which is a raw memory device combined with a local controller (e.g., local media controller 105) for media management within the same memory device package. An example of a managed memory device is a managed NAND (MNAND) device.

The controller 115 and/or a memory device 103 can include a memory manager 113 configured to perform operations related to the management of the characteristics of a random access memory 112 attached to the processing device 118 of the host system 102 via a compute express link (CXL) fabric 121. Such characteristics can include capacity, bandwidth, latency, and/or power consumption level. In some embodiments, the controller 115 in the memory sub-system 101 includes at least a portion of the memory manager 113. In other embodiments, or in combination, the fabric 121, the controller 116 and/or the processing device 118 in the host system 102 can include at least a portion of the memory manager 113. For example, the fabric 121, the controller 115, the controller 116, and/or the processing device 118 can include logic circuitry implementing the memory manager 113. For example, the switches and/or controller of the fabric 121, the controller 115, or the processing device 118 (processor) of the host system 102, can be configured to execute instructions stored in memory for performing the operations of the memory manager 113 described herein. In some embodiments, the memory manager 113 is implemented in an integrated circuit chip disposed in the memory sub-system 101 or a controller of the fabric 121. In other embodiments, the memory manager 113 can be part of firmware of the memory sub-system 101, an operating system of the host system 102, a device driver, a set of agents running in CXL switches of the fabric 121, a part of a fabric manager running a controller of the CXL fabric 121, or an application, or any combination thereof.

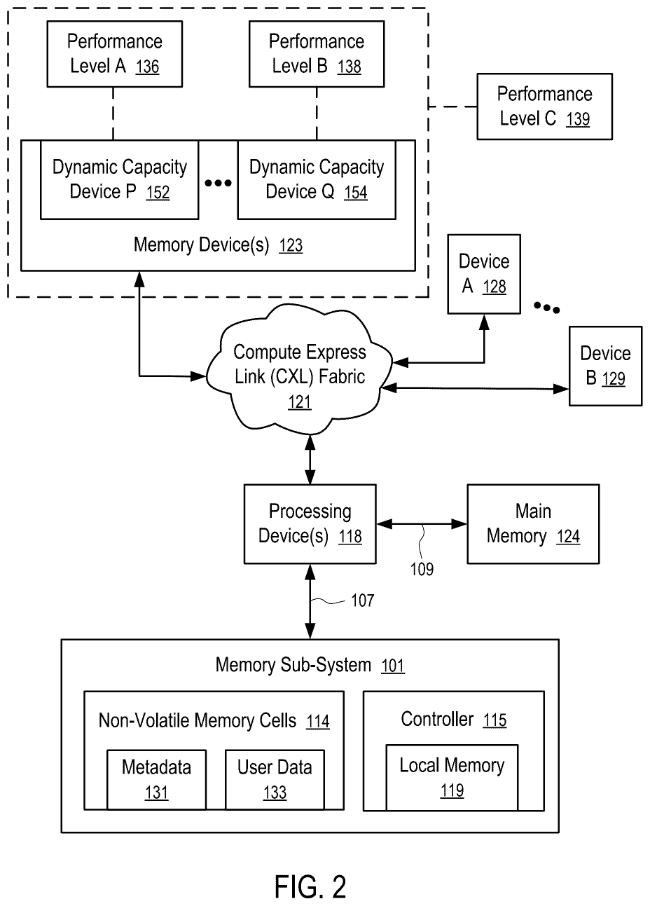

The random access memory 112 can be implemented using resources allocated from a plurality of memory devices 123 attached to the CXL fabric 121 as in FIG. 2 to FIG. 4. For example, the memory devices 123 can offer dynamic capacity devices (e.g., 152, . . . , 154) that can be attached to a host processor (e.g., processing device 118) to provide a secondary tier memory for the host processor to supplement the main memory 124 of the host system 102. The memory manager 113 can be configured to request the dynamic capacity devices (e.g., 152, . . . , 154) to change their capacity sizes a run time to effectively change the characteristics (e.g., capacity, bandwidth, latency, power consumption) of the random access memory 112 functioning as the secondary tier memory. Optionally, the memory manager 113 implemented in the fabric 121 can use a look up table to map addresses used by the processing device 118 in memory access requests into addresses in the memory devices 123. The memory access requests are routed through the fabric 121 according to the look up table/address mapping. The memory manager 113 can change the characteristics (e.g., capacity, bandwidth, latency, power consumption) of the random access memory 112 through dynamically changing the look up table without restarting the computing system 100 and/or the host system 102.

FIG. 2 to FIG. 4 show techniques to provide a secondary tier memory according to some embodiments. For example, the techniques of FIG. 2 to FIG. 4 can be implemented in the computing system 100 of FIG. 1 to provide the random access memory 112 over the CXL fabric 121.

In FIG. 2 to FIG. 4, a compute express link (CXL) fabric 121 is configured to provide a random access memory (e.g., 112) using a set of memory devices 123 having random access memory cells that are addressable using physical memory addresses in the memory devices 123.

For example, the compute express link (CXL) fabric 121 can include a set of CXL switches interconnected via CXL connections and controlled at least in part by a controller. The memory devices 123 are connected to the switches in the fabric 121 via point to point CXL connections; and the controller of the CXL fabric 121 is configured to direct how memory access communications are routed by the CXL switches through the fabric 121 to or from the memory devices 123.

The memory devices 123 can implement a plurality of dynamic capacity devices (e.g., 152, . . . , 154). Each respective dynamic capacity device (e.g., 152, . . . , or 154) can be attached over the CXL fabric 121 to a host processor, such as a processing device 118, or another device 128 or 129. The respective dynamic capacity device (e.g., 152, . . . , or 154) can be implemented by a memory device 123 that implements a plurality of dynamic capacity devices, each attached over the fabric 121 to a different host processor. The respective dynamic capacity device (e.g., 152, . . . , or 154) can determine a maximum amount of memory resources currently available in the memory device 123 and can allocate up to the maximum amount as its capacity. The host processor (e.g., processing device 118 or another device 128 or 129) can determine, in view of the maximum amount, a desired capacity size of the respective dynamic capacity device (e.g., 152, . . . , or 154) that is no larger than the maximum amount. Using a communication protocol according to a standard of compute express link (CXL), the host processor can request the respective dynamic capacity device (e.g., 152, . . . , or 154) to configure itself to have the capacity size identified by the host processor. The respective dynamic capacity device (e.g., 152, . . . , or 154) can effectuate the capacity size change without restarting the memory device 123, the host processor, the host system 102, and/or the computing system 100.

In general, the memory devices 123 can service, via their connections to the fabric 121, multiple host processors, such as processing device 118 (e.g., central processing unit (CPU), system on a chip (SoC)), and other devices 128, . . . , 129 (e.g., artificial intelligence (AI) accelerator, graphical processing unit (GPU), network interface card). A subset of the dynamic capacity devices 152, . . . , 154 offered by the memory devices 123 can be attached to one host processor; and one or more other subsets can be attached to one or more other host processors.

Due to the differences in the memory devices 123 and/or the locations of the memory devices 123 in the network of CXL connections in the fabric 121, the dynamic capacity devices 152, . . . , 154 offered by the different memory devices 123 can have different performance levels 136, . . . , 138 in bandwidth, latency, and/or power consumption. Different combinations of capacity sizes of the dynamic capacity devices 152, . . . , 154 attached to a host processor (e.g., processing device 118, device 128 or 129) can lead to differently implemented performance levels 139 of the random access memory 112 for the host processor.

In one implementation, a memory manager 113 running in the host processor is configured to determine the desired capacity sizes of the dynamic capacity devices 152, . . . , 154 attached to the host processor such that the performance level 139 of the random access memory 112 attached via the fabric 121 to the host processor meets, or matches with, the current requirements of one or more applications running in the host processor. As the runtime status of the applications changes, the current requirements can change; and in response, the host processor can request the dynamic capacity devices 152, . . . , 154 to change their capacity sizes such that the performance level 139 of the random access memory 112 meets, or matches with, the current requirements.

In another implementation, the host processor communicates its memory requirements to a controller of the CXL fabric 121. The memory manager 113 running in the controller can request the dynamic capacity devices 152, . . . , 154 to change their capacity sizes on behalf of the host processor such that the performance level 139 of the random access memory 112 attached to the host processor satisfies, or approximately matches with, the current requirements.

In general, the performance level 139 of the random access memory 112 attached over the fabric 121 to the host processor can change in response to the communications workload applied to the fabric 121 and/or the memory access workload applied to the memory devices 123. The memory manager 113 (e.g., running in the host processor or in the controller of the fabric 121) can monitor the runtime performance level 139 of the random access memory 112 and request the dynamic capacity devices 152, . . . , 154 to change their capacity sizes such that the runtime performance level 139 of the random access memory 112 satisfies, or approximately matches with, the current requirements of the host processor.

Optionally, the memory devices 123 may not offer dynamic capacity devices for attaching to a host processor. Instead, the controller of the compute express link fabric 121 can offer a dynamic capacity device attachable to each host processor. The controller can dynamically allocate memory resources from the memory devices 123 to implement the dynamic capacity device such that the performance level 139 of the random access memory 112 provided via the dynamic capacity device offered by the controller satisfies, or approximately matches with, the current requirements of the host processor.

Optionally, the memory devices 123 offer dynamic capacity devices 152, . . . , 154 that are attached to the controller of the compute express link fabric 121. The controller in turn offers a dynamic capacity device attachable to a host processor. The controller uses a subset of the dynamic capacity device 152, . . . , 154 offered by the memory devices 123 to implement the dynamic capacity device offered by the controller over the fabric 121 to the host processor. The controller can dynamically adjust the capacity sizes of the dynamic capacity devices (e.g., 152, 154) in the subset such that the performance level 139 of the random access memory 112 provided via the dynamic capacity device offered by the controller satisfies, or approximately matches with, the current requirements of the host processor.

In FIG. 2, a main memory 124 is connected to a host processor (e.g., the processing device(s) 118) via a memory bus 109 (e.g., a double data rate (DDR) bus); and a memory sub-system 101 (e.g., as in FIG. 1) is connected to the processing device(s) using a peripheral bus 107 (e.g., a peripheral component interconnect express (PCIe) bus) that is different and separate from the memory bus 109. The main memory 124 is the primary tier memory of the host processor; and the random access memory 112 provided over the CXL fabric 121 and implemented using the dynamic capacity devices 152, . . . , 154 is the secondary tier memory of the host processor.

Optionally, a memory controller 116 (e.g., configured in the host processor) can manage the placement and movement of memory pages between the primary tier memory and the secondary tier memory. For example, applications running in the host processor (e.g., processing device 118) can use virtual memory addresses to access a page of memory. The page can be physically in the primary tier memory or in the secondary tier memory. When a page currently in the primary tier memory has not been used for more than a threshold length of time period, the memory controller 116 can move the page to the secondary tier memory and thus free up memory resources previously used by the page in the primary tier memory. The freed memory resources can then be used for a more frequently and/or recently accessed memory page.

When memory pages accessed by the applications are all in the primary tier memory, the memory controller 116 can decide that it is not necessary to have a large secondary tier memory; and a memory manager 113 in the memory controller 116 can request the dynamic capacity devices (e.g., 152, 154) that are attached to the host processor (e.g., processing device 118) and/or the memory controller 116 to reduce their capacity sizes. Reducing the capacity sizes of the dynamic capacity devices (e.g., 152, 154) in the memory devices 123 frees up resources in the memory devices 123 such that other dynamic capacity devices can increase their capacity sizes to service other host processors (e.g., devices 128, 129).

When memory pages accessed by the applications exceed the capacity of the primary tier memory, the memory controller 116 can decide to swap some pages from the primary tier memory to the secondary tier memory. When the current capacity size of the random access memory 112 in the secondary tier memory is insufficient, the memory controller 116 can request one or more of the dynamic capacity devices (e.g., 152, 154) that are attached to the host processor (e.g., processing device 118) and/or the memory controller 116 to increase their capacity sizes, in view of the current availability of memory resources in the memory devices 123.

When the activities of swapping pages between the primary tier memory and the secondary tier memory increase, the memory controller 116 can determine that the bandwidth and/or latency of the secondary tier memory limits the performance of the applications running in the host processor. Thus, the memory controller 116 can request one or more of the dynamic capacity devices (e.g., 152, 154) that are attached to the host processor (e.g., processing device 118) and/or the memory controller 116 to change their capacity sizes in a way to increase the performance level 139 of the random access memory 112 in the secondary tier memory.

When the activities of swapping pages between the primary tier memory and the secondary tier memory decrease, the memory controller 116 can decide that the current performance level in bandwidth and/or latency of the secondary tier memory can be excessive in view of the reduced performance demand of the applications running in the host processor. Thus, the memory controller 116 can request one or more of the dynamic capacity devices (e.g., 152, 154) that are attached to the host processor (e.g., processing device 118) and/or the memory controller 116 to change their capacity sizes in a way to decrease the performance level 139 of the random access memory 112 in the secondary tier memory, which can free up resources in the memory devices 123 for use by other host processors (e.g., devices 128, 129).

Thus, the capacity, bandwidth, latency, and/or power consumption levels of the random access memory 112 in the secondary tier memory, attached over the fabric 121 to the host processor (e.g., processing device 118) and implemented using random access memory cells in the memory devices 123, can change in view of the real time memory activities and demands of the applications running in the host processor.

Alternatively, the memory controller 116 can be configured to send the memory configuration requirements (e.g., capacity, bandwidth, latency, and/or power consumption) to the controller of the fabric 121 to cause the controller to adjust the implementation of the secondary tier memory without restarting the host processor, the host system 102, and/or the computing system 100.

Optionally, the memory controller 116 can be configured to use at least a portion of the main memory 124 as a cache memory for accessing the random access memory 112 in the secondary tier memory.

In some implementations, a portion of the memory of the host system 102 as a whole, including the main memory 124 in the primary tier memory of the processing devices 118 and the random access memory 112 in the secondary tier memory, can be allocated to support the operations of the memory sub-system 101.

For example, a portion of the memory can be allocated as a host memory buffer (HMB) of the memory sub-system 101. The host memory buffer can be used to buffer a portion of a logical to physical translation table of the memory sub-system 101.

The memory sub-system 101 can use its non-volatile memory cells 114 (e.g., NAND memory) for persistent storage of metadata 131, such as the logical to physical translation table. The storage capacity of the memory cells 114 is used to store both user data 133 and the metadata 131 about the storage of the user data 133.

Accessing the non-volatile memory cells 114 for address translation computations can be slower than accessing the host memory buffer. To improve the speed of address translation operations, the memory manager 113 in the memory sub-system 101 can load an actively used portion of the logical to physical translation table into its local memory 119, and load another portion of the logical to physical translation table that is likely to be used into the host memory buffer. Such an arrangement can reduce the need to read and write the non-volatile memory cells 114 to use and update the logical physical translation table and thus improve the overall performance of the memory sub-system 101 in providing its storage services. Optionally, the memory sub-system 101 can use a portion of the logical to physical translation table in the host memory buffer directly in address translation without loading the portion into the local memory 119.

When the workload for the memory sub-system 101 changes, the memory demand (e.g., resources need for the host memory buffer) can change. The memory manager 113 can adjust the performance level 139 and/or the capacity size of the secondary tier memory based on the memory demand of the memory sub-system 101.

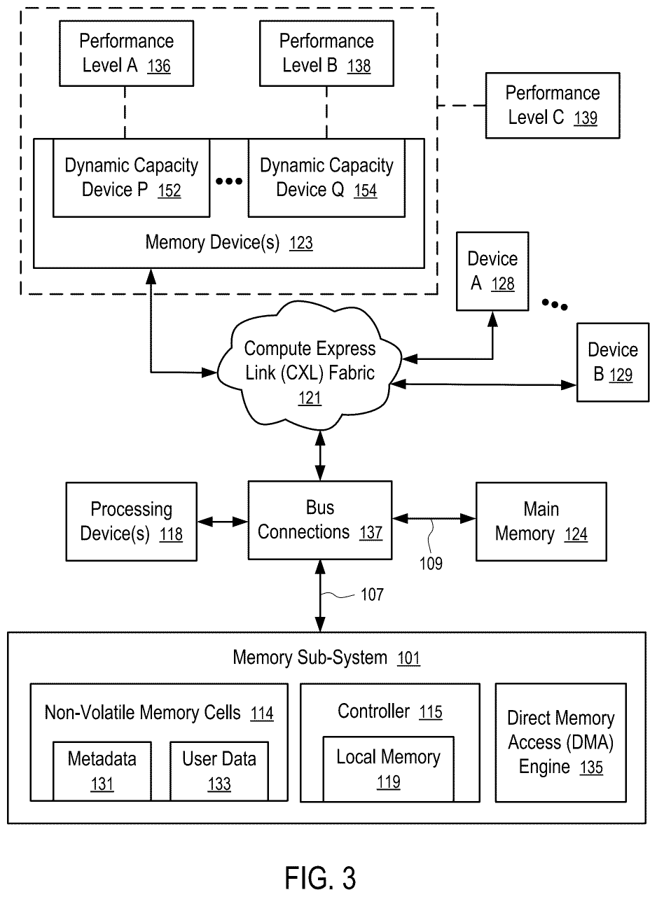

In some implementations, the memory sub-system 101 can access, over the CXL fabric 121, the host memory buffer in the memory devices 123 without going through and/or without assistance from the processing devices 118 connected to the main memory 124, as in FIG. 3

In FIG. 3, a set of bus connections 137 can interconnect the peripheral bus 107 (e.g., a peripheral component interconnect express (PCIe) bus), the memory bus 109 (e.g., a double data rate (DDR) bus) and the CXL fabric 121. The memory sub-system 101 is configured with a direct memory access (DMA) engine 135 operable to access the memory in the host system 102, including the main memory 124 and the random access memory (e.g., 112) implemented using the memory devices 123 connected via the fabric 121.

Using the DMA engine 135 the memory manager 113 of the memory sub-system 101 can copy a portion of the logical physical translation table from the local memory 119 to the host memory buffer in the memory devices 123. Thus, the local memory 119 can be freed for storing another portion of the logical to physical translation table for active use, or for other memory usages.

For example, the memory sub-system 101 can retrieve a portion of the logical to physical translation table from the non-volatile memory cells 114 into the local memory 119 and then copy the portion to the host memory buffer (e.g., for buffering/caching, and/or for reference in address translation).

For example, the memory sub-system 101 can store a portion of the logical to physical translation table in the local memory 119 for active address translation operations. When subsequent operations do not use the portion for a period of time, the memory sub-system 101 can offload the portion to the host memory buffer for buffering and to load another portion of the logical to physical translation table (e.g., from the host memory buffer, or the memory cells 114) for active use.

When a portion of the logical physical translation table in the host memory buffer is to be used actively, the DMA engine 135 can fetch the portion of the logical physical translation table from the host memory buffer into the local memory 119 without assistance from the processing device(s) 118.

In some implementations, the DMA engine 135 and/or the memory sub-system 101 can function as a host of the main memory 124 and/or the random access memory (e.g., 112) implemented using the memory devices 123 connected via the fabric 121. Thus, the memory sub-system 101 can configure a portion of the local memory 119 as a cache memory for accessing the random access memory (e.g., 112) implemented using the memory devices 123 connected to the fabric 121, including the host memory buffer.

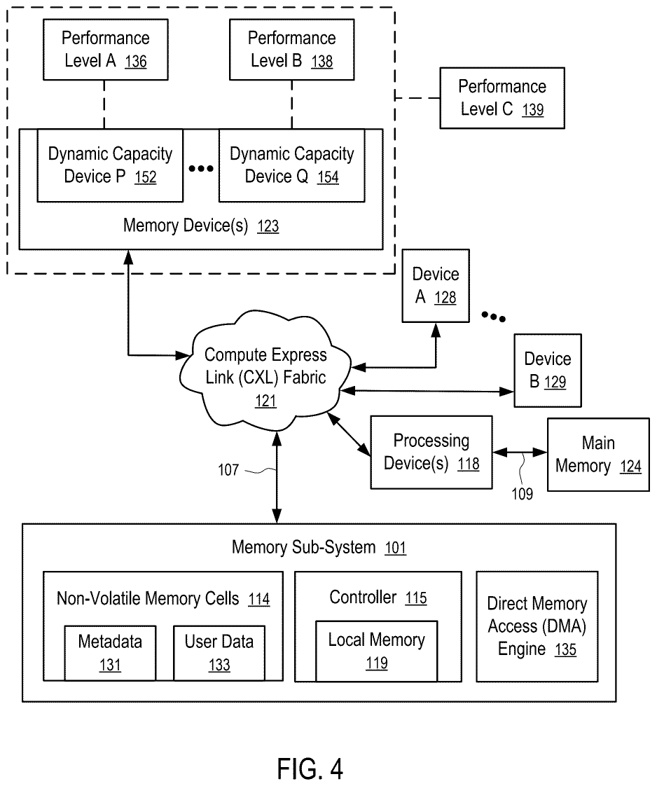

In some implementations, the connection 107 to the memory sub-system 101 is also a compute express link (CXL) connection to the fabric 121, as in FIG. 4.

When the memory sub-system 101 is connected to the fabric 121 via a compute express link (CXL) connection, the memory sub-system 101 and/or a direct memory access (DMA) engine in the memory sub-system 101 can use the random access memory (e.g., 112) implemented using the memory devices 123 connected via the fabric 121 in a way similar to the processing device(s) 118 using the random access memory (e.g., 112). The memory sub-system 101 can dynamically allocate a portion of the random access memory (e.g., 112) as its host memory buffer to store the entire logical to physical translation table or a portion of it, without assistance from the processing device(s) 118 connected to the main memory 124.

In some implementations, when the memory sub-system 101 is connected to the fabric 121 via a compute express link (CXL) connection, a controller of the CXL fabric 121 can use the storage space of the non-volatile memory cells 114 to provide a logical memory device (e.g., a dynamic capacity device) having a memory space of random access memory accessible by various hosts connected to the fabric 121, such as the processing device(s) 118 and other devices 128, . . . , 129 (e.g., artificial intelligence (AI) accelerator, graphical processing unit (GPU)), as further discussed below. Thus, the devices (e.g., 118, 128, 129) connected to the fabric 121 can virtually access the memory sub-system 101 over the fabric 121 as if the storage space of the memory sub-system 101 (e.g., the capacity of the non-volatile memory cells 114) were random access memory.

Different portions of the capacity of a storage device (e.g., solid-state drive) are typically configured to be addressed for access using logical block addressing (LBA) addresses. Each LBA address represents a predetermined amount of capacity (e.g., 512 bytes, 4 KB), which is significantly larger than the capacity represented by a memory address for accessing a random access memory.

Different portions of a random access memory (e.g., 112, main memory 124) are typically configured to be addressed for access using memory addresses. Each memory address represents a predetermined amount of capacity (e.g., one byte, eight bytes, or 128 bytes), which is significantly smaller than the capacity of an LBA address for accessing a storage device.

Communication protocols for accessing via LBA addresses and for accessing via memory addresses are typically adapted differently to accommodate typical patterns of accessing: large chunks of data accessed via LBA addresses and small chunks of data accessed via memory addresses.

For example, when a large chunk of data is accessed via an LBA address, it is possible to use a relatively large amount of communication overhead to implement enhanced features without significantly degrading the system performance. In contrast, when a small chunk of data is accessed via a memory address, an increase in communication overhead can significantly degrade the system performance. Thus, block-based storage devices and random access memory devices are typically not interchangeable in their usages in a computing system.

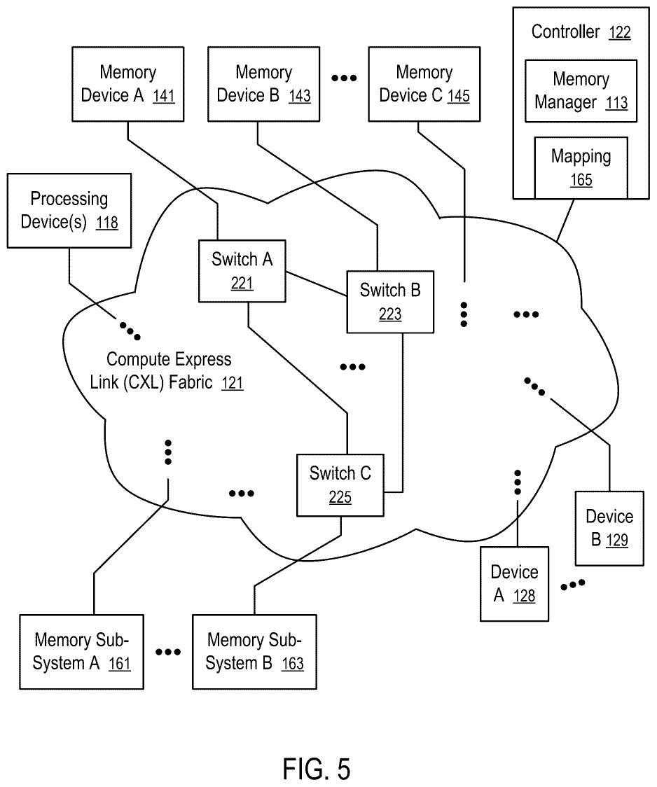

FIG. 5 shows a compute express link fabric configured to provide a secondary tier memory according to one embodiment. For example, the compute express link fabric 121 discussed above in connection with FIG. 1 to FIG. 4 can be implemented as in FIG. 5.

In FIG. 5, the compute express link fabric 121 includes a plurality compute express link switches (e.g., 221, 223, 225). Each of the switches (e.g., 221, 223, or 225) has a plurality of ports connected to separate compute express link connections. A switch (e.g., 221, 223, or 225) is configured to route a memory access request or response received at one port to another. A compute express link connection in the fabric 121 can connect a port of one switch to a port of another switch, or to a memory device (e.g., 141, 143, or 145), or to a memory sub-system (e.g., 161, or 163), or to a host processor, such as a processing device 118 (e.g., a CPU, a CPU core, an SoC) or another device (e.g., 128 or 129, such as a GPU, a GPU core, an AI accelerator).

A controller 122 of the fabric 121 can control the switches (e.g., 221, 223, or 225) of the fabric 121 to implement a look up table or address mapping 165 for routing memory access requests having addresses specified by a host processor (e.g., processing device 118, or device 128 or 129) into addresses of random access memory cells in the memory devices 141, 143, . . . , 145.

The controller 122 can include a fabric manager and/or a memory manager 113 to adjust the mapping 165 for implementing a random access memory 112 in a secondary memory tier using memory resources in the memory devices 141, 143, . . . , 145, with or without the use of techniques of dynamic capacity devices (e.g., 152, 154) offered by the memory devices 141, 143, . . . , 145. Optionally, the memory resources are provided by the memory devices 141, 143, . . . , 145 in the form of dynamic capacity devices (e.g., 152, . . . , 154) attached to the controller 122 over the fabric 121. Alternatively, the memory resources can be provided by the memory devices 141, 143, . . . , 145 via random access memory cells addressable by the controller 122 without the use of the dynamic capacity devices offered by the memory devices 141, 143, . . . , 145; and thus, the techniques can be used even when the memory devices 141, 143, . . . , 145 do not implement the functions and protocols of dynamic capacity devices.

In some implementations, the memory manager 113 (and/or the fabric manager) is configured on a centralized device in communication with the switches 221, 223, . . . , 225 in the fabric 121. In other implementations, the memory manager 113 (and/or the fabric manager) is implemented via a set of agents each running in one of the switches 221, 223, . . . , 225. The agents can be configured to make separate and independent routing decisions. The agents can collectively implement the operations of the controller 122 by each routing memory access traffic from one port of a switch to another port of the same switch in which the agent is running.

The controller 122 of the compute express link fabric 121 (e.g., as discussed above in connection with FIG. 1 to FIG. 4) can monitor the changing memory/storage usage patterns and/or the real time performance level 139 of a random access memory 112 in the secondary tier memory of a host processor (e.g., device 118, 128, or 129). When the real time performance level 139 deviates from a requirement from the host processor, the controller 122 can change the mapping 165 at the run time such that the performance level 139 of the random access memory 112 in the secondary tier memory meets, or matches with, the performance requirement specified by the host processor (e.g., processing device 118, or device 128 or 129).

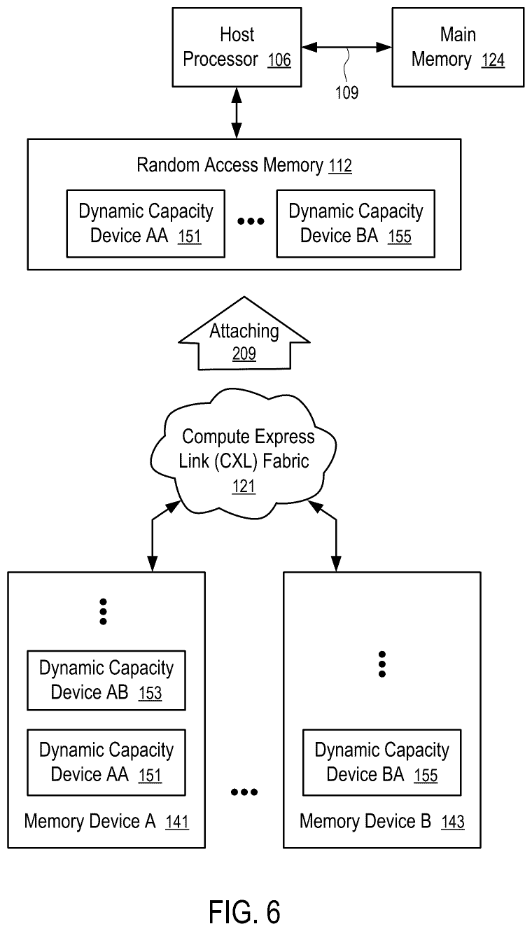

FIG. 6 shows the attaching of dynamic capacity devices over a compute express link fabric to provide a random access memory according to one embodiment. For example, the random access memory 112 in the secondary tier memory of a host processor 106 (e.g., processing device 118, or device 128 or 129) in a computing system 100 of FIG. 1 can be implemented via attaching dynamic capacity devices as in FIG. 6 over a compute express link fabric 121 configured as in FIG. 2 to FIG. 5.

In FIG. 6, the host processor 106 has a main memory 124 that is connected to the host processor 106 via a memory bus 109 to provide a primary tier memory of the host processor 106.

Further, the host processor 106 can have a random access memory 112 in a secondary tier memory that is implemented via a plurality of memory devices (e.g., 141, . . . , 143) connected over a compute express link fabric 121.

Each of the memory devices (e.g., 141, 143) can offer a plurality of dynamic capacity devices (e.g., 151, 153, . . . ; 155, . . . ). At least one of the dynamic capacity devices (e.g., 151, 153, . . . ) of a memory device 141 can be attached over the compute express link fabric 121 to the host processor 106. For example, during a boot up process, the operation of attaching 209 some dynamic capacity devices (e.g., 151, . . . , 155) to the host processor 106 is performed. For example, a dynamic capacity device (e.g., 151, or 155) attached to the host processor 106 can be configured for exclusive use by the host processor 106; and other host processors are prevented from accessing, over the CXL fabric 121, the dynamic capacity device (e.g., 151, or 155) attached to the host processor 106.

For example, a dynamic capacity device 151 of the memory device 141 is attached to the host processor 106 to implement a portion of the random access memory 112, where the size of the portion is adjustable via adjusting the capacity size of the dynamic capacity device 151; and a dynamic capacity device 155 of the memory device 143 is attached to the host processor 106 to implement another portion of the random access memory 112, where the size of the portion is adjustable via adjusting the capacity size of the dynamic capacity device 155.

Each of the dynamic capacity devices (e.g., 151, 155) can have a capacity size that is dynamically requested by the host processor 106. A memory device (e.g., 141) is configured to dynamically allocate memory resources within the memory device (e.g., 141) to satisfy the capacity size request from the host processor 106. The capacity size of the random access memory 112 is the sum of the capacity sizes of the dynamic capacity devices 151, . . . , 155 attached to the host processor 106. To access a location in the random access memory 112, the host processor 106 identifies a dynamic capacity device (e.g., 151) and a memory address within the current capacity size of the dynamic capacity device (e.g., 151).

For example, the host processor 106 can cause the random access memory 112 to be implemented using memory resources from the memory device 141 but not memory resources from other memory devices (e.g., 143) by requesting the dynamic capacity device 151 to have a capacity size that is equal to the capacity size of the random access memory 112, and requesting the other dynamic capacity devices (e.g., 155) attached to the host processor 106 to have capacity sizes equal to zero. As a result, the characteristics (e.g., bandwidth, latency, power consumption) of the random access memory 112 are determined by the memory device 141 and its position in the fabric 121 relative to the host processor 106.

For example, the host processor 106 can cause the random access memory 112 to be implemented using memory resources from the memory devices 141 and 143 but not memory resources from other memory devices by requesting the dynamic capacity devices 151 and 155 to have capacity sizes that are larger than zero, and requesting the other dynamic capacity devices attached to the host processor 106 to have capacity sizes equal to zero. As a result, the capacity size of the random access memory 112 is equal to the sum of the capacity sizes of the dynamic capacity devices 151 and 155; and the characteristics (e.g., bandwidth, latency, power consumption) of the random access memory 112 are determined by the memory devices 141 and 143, the ratio of their capacity sizes, and their positions in the fabric 121 relative to the host processor 106.

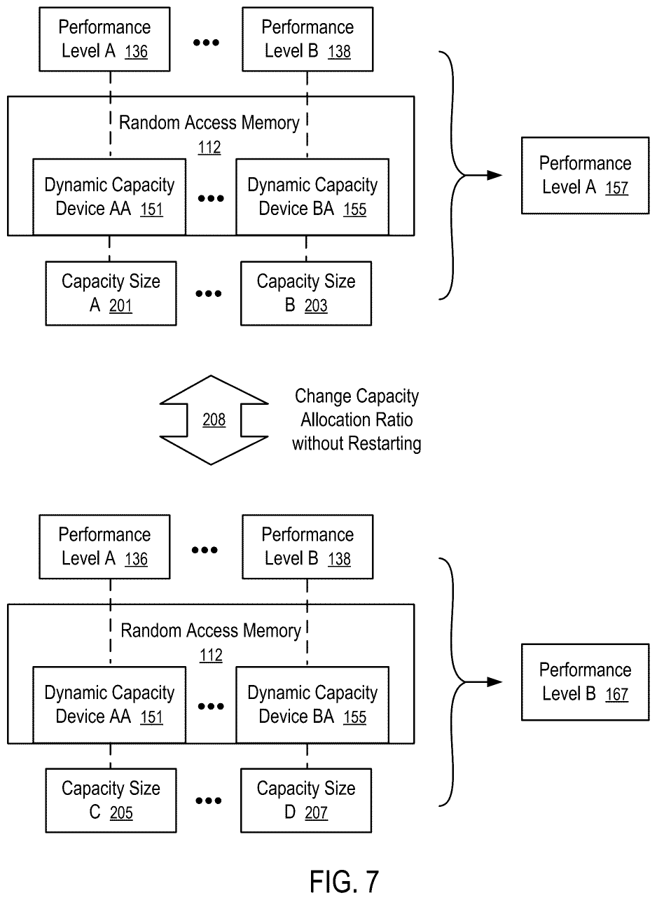

The host processor 106 can request changes in the capacity sizes of the dynamic capacity devices 151, . . . , 155 attached to the host processor 106 without a need to restart the host processor 106, the memory devices 141, . . . , 143, and/or the computing system 100 containing the host processor 106 and the memory devices 141, . . . , 143, as in FIG. 7.

FIG. 7 shows a technique to dynamically adjust the performance level of a random access memory of a host system according to one embodiment. For example, the performance level of the random access memory 112 attached to a host processor 106 as in FIG. 6 can be adjusted using the technique of FIG. 7.

In FIG. 7, a random access memory 112 (e.g., configured as a secondary tier memory of a host processor 106) is implemented using a set of dynamic capacity devices 151, . . . , 155 provided by different memory devices (e.g., memory devices 141, 143, . . . ).

Due to the differences in the memory devices and/or their locations in a compute express link fabric 121, the dynamic capacity devices 151, . . . , 155 can have different performance levels 136, . . . , 138 in servicing the host processor 106 over the fabric 121.

When the dynamic capacity devices 151, . . . , 155 have capacity sizes 201, . . . , 203 respectively, the random access memory 112 effectively has a nominal performance level 157 (e.g., in bandwidth, latency, and/or power consumption). When the dynamic capacity devices 151, . . . , 155 have capacity sizes 205, . . . , 207 respectively, the random access memory 112 effectively has a different nominal performance level 167 (e.g., in bandwidth, latency, and/or power consumption), due to the combining of the different performance levels 136, . . . , 138 using different ratios of capacity size.

Thus, the host processor 106 can reconfigure the random access memory 112 to have performance levels 157 and 167 through changing the allocation ratio of the capacity sizes of the dynamic capacity devices 151, . . . , 155. The change 208 can be effectuated without system restarting and without adding or removing memory devices attached to the host processor 106. The host processor 106 can work with the same set of dynamic capacity devices 151, . . . , 155 in accessing the random access memory 112.

Optionally, the change 208 can be made such that the sum of the capacity sizes 201, . . . , 203 is equal to the sum of the capacity sizes 205, . . . , 207. Thus, the change 208 does not alter the capacity size of the random access memory 112.

Optionally, the change 208 can be made such that the sum of the capacity sizes 201, . . . , 203 is larger than (or smaller than) the sum of the capacity sizes 205, . . . , 207. Thus, the change 208 can be implemented to increase (or decrease) the capacity size of the random access memory 112.

When the sum of the capacity sizes 201, . . . , 203 is different from the sum of the capacity sizes 205, . . . , 207 but the ratio among the capacity sizes 201, . . . , 203 is same as the ratio among the capacity sizes 205, . . . , 207, the change 208 can be effectuated to change the capacity size of the random access memory 112 while keeping the performance levels 157 and 167 the same.

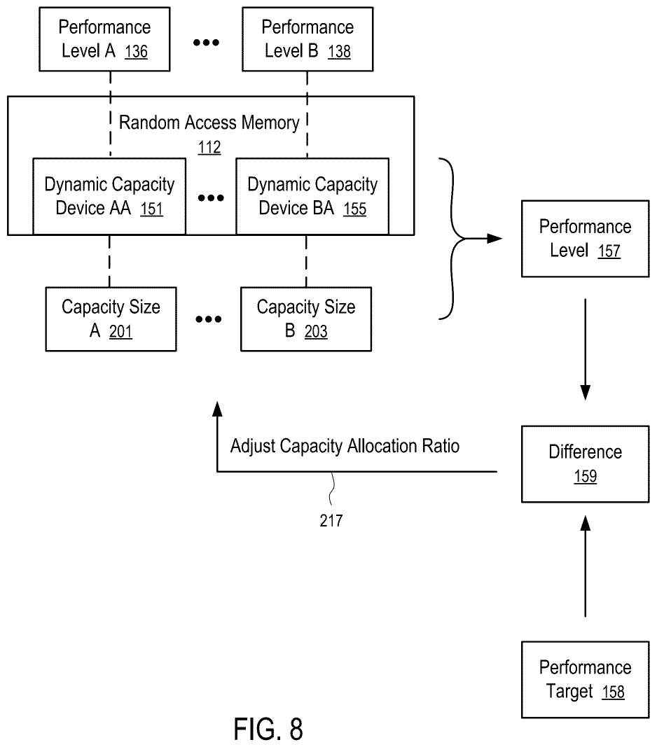

In general, the performance level of the random access memory 112 can change as a result of changing workloads applied to the compute express link fabric. Thus, the real-time performance level (e.g., 157 or 167) of the random access memory 112 servicing the host processor 106 can deviate from the nominal performance level represented by ratios of capacity sizes (e.g., 201 to 203; or 205 to 207). Optionally, the host processor 106 can track the real time performance level of the random access memory 112 and change the ratio among the capacity sizes (e.g., 201, . . . , 203) of the dynamic capacity devices 151, . . . , 155 so that the run time performance level (e.g., 157) of the random access memory 112 meets, or matches with, a performance target, as in FIG. 8.

FIG. 8 illustrates a technique to determine capacity allocations for dynamic capacity devices to implement a random access memory having a performance target according to one embodiment. For example, the performance level of the random access memory 112 attached to a host processor 106 as in FIG. 6 can be adjusted using the technique of FIG. 8 to meet or match with a performance target 158 specified by the host processor 106.

In FIG. 8, the random access memory 112 is provided via a plurality of dynamic capacity devices 151, . . . , 155 (e.g., as in FIG. 6 and FIG. 7). The dynamic capacity devices 151, . . . , 155 have respective performance levels 136, . . . , 138 and respective capacity sizes 201, . . . , 203. As a result, the random access memory 112 as a whole has a performance level 157 in servicing the memory access requests from a host processor 106.

The host processor 106 can measure the performance level 157 at the run time of processing the instructions of one or more applications running in the host processor 106. When the performance level 157 deviates from a performance target 158, the host processor 106 can dynamically adjust 217 the capacity allocation ratio among the capacity sizes 201, . . . , 203 of the dynamic capacity devices 151, . . . , 155 to reduce or eliminate the difference 159 between the performance level 157 and the performance target 158.

The applications running in the host processor 106 can request for allocation of memory for their uses. When the total amount of memory to be allocated exceeds the sum of the current capacity sizes 201, . . . , 203, the host processor 106 can request the increase of the capacity size (e.g., 201) of one or more dynamic capacity devices (e.g., 151) to meet the memory demand of the applications. Optionally, the capacity size increases can be made to keep the performance level 157 at or above the performance target 158.

For example, the host processor 106 can identify a dynamic capacity device (e.g., 151), among the plurality of dynamic capacity devices 151, . . . , 155 attached to the host processor 106, having a performance level 136 that is at or above the performance target 158 to increase its capacity to meet the increased memory demand while keeping the performance level 157 of the random access memory 112 at or above the performance target 158.

When an application running in the host processor 106 returns an amount of memory previously allocated for its uses, the host processor 106 can optionally decrease the capacity size of the random access memory 112 by requesting one or more dynamic capacity devices (e.g., 151) to decrease their capacity sizes. Decreasing their capacity sizes can release memory resources in respective memory devices (e.g., 141, 143); and the release memory resources become available for use by other dynamic capacity devices (e.g., 153) provided by the memory devices (e.g., 141).

For example, the performance level 157 can be measured for the bandwidth (or latency, or power consumption) of the random access memory 112 servicing the host processor 106. When the demands of the applications running in the host processor 106 raises the performance target 158, the host processor 106 can request one or more dynamic capacity devices (e.g., 151) having performance levels (e.g., 136) at or above the performance target 158 to increase their capacity sizes (e.g., 201) and request other dynamic capacity devices (e.g., 155) to decrease their capacity sizes (e.g., 203).

Similarly, when the demands of the applications running in the host processor 106 reduces the performance target 158, the host processor 106 can request one or more dynamic capacity devices (e.g., 151) having performance levels (e.g., 136) above the performance target 158 to decrease their capacity sizes (e.g., 201) and request other dynamic capacity devices (e.g., 155) to increase their capacity sizes (e.g., 203). Thus, high performance memory resources can be released in the respective memory devices (e.g., 141) for use by other dynamic capacity devices (e.g., 153) provided by the memory devices (e.g., 141).

In general, the performance level 157 of the random access memory 112 is within the range identified by the highest performance level (e.g., 136) of the dynamic capacity devices 151, . . . , 155, and the lowest performance level (e.g., 138) of the dynamic capacity devices 151, . . . , 155 used to implement the random access memory. The host processor 106 can be configured to adjust 217 the capacity allocation radio of the dynamic capacity devices 151, . . . , 155 to reduce or minimized the difference 159.

Optionally, different applications running concurrently in the same host processor 106 in a time period can have different memory performance level requirements. Thus, the performance target 158 can include a plurality of memory performance level requirements, each has a corresponding allocation size. The host processor 106 can map the segments of the random access memory 112 having the corresponding requested memory performance levels and allocation sizes to the memory resources in the dynamic capacity devices 151, . . . , 155 such that the sizes of the segments and the performance levels of the segments are all satisfied (or closely matched).

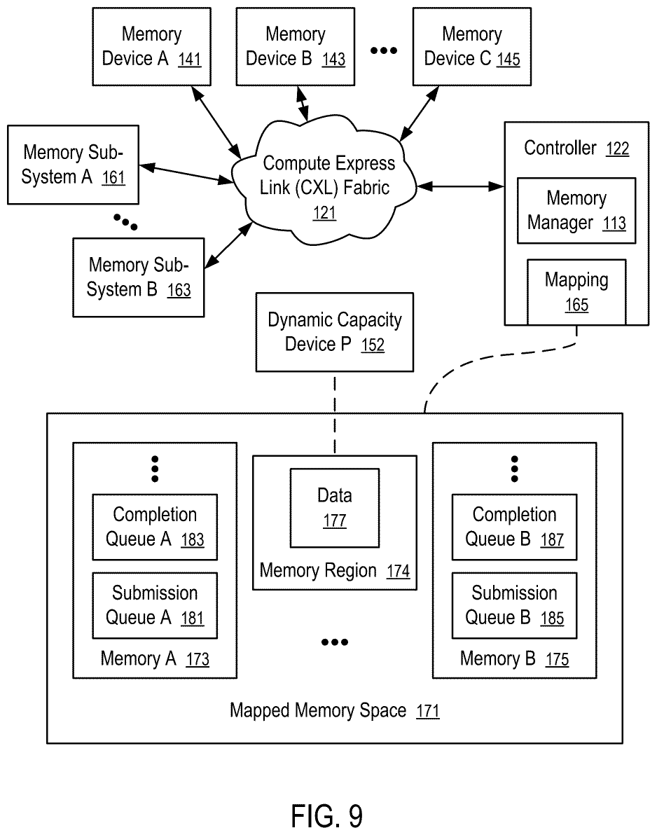

FIG. 9 shows a mapped memory space implemented via a compute express link fabric to provide a dynamically adjustable random access memory according to one embodiment. For example, the random access memory 112 of FIG. 1 provided over a compute express link fabric 121 can be implemented using a mapped memory space 171 and a controller 122 of the fabric 121.

In FIG. 9, the mapped memory space 171 is implemented via the controller 122 of the compute express link (CXL) fabric 121 connecting a plurality of memory devices 141, 143, . . . , 145 having random access memory cells (e.g., as in FIG. 2 to FIG. 6).

A host processor (e.g., 106) can be a processing device 118, or another device (e.g., 128, or 129 in FIG. 2 to FIG. 5). The host processor 106 can send a memory access request using a memory address in the mapped memory space 171 to access the random access memory 112 connected to the host processor 106 via the fabric 121.

A memory region 174 of the mapped memory space 171 can correspond to the random access memory 112 in a secondary tier memory of the host processor 106.

For example, the controller 122 can offer a dynamic capacity device 152 that has a set of memory addresses in the memory region 174. During a boot up process, the dynamic capacity device 152 is attached to the host processor 106. When the host processor 106 accesses the memory addresses in the dynamic capacity device 152, the controller 122 maps the memory access requests to one or more portions in the memory devices 141, 143, . . . , 145 connected to the fabric 121. Thus, the memory devices 141, 143, . . . , 145 do not have to implement the functions and protocols of dynamic capacity devices; and the dynamic capacity device 152 can be implemented, via the controller 122 mapping 165 memory addresses in the memory region 174 to the memory devices 141, 143, . . . , 145, using the memory resources allocated from one or more of the memory devices 141, 143, . . . , 145.

Since the memory region 174 is formulated based on the identity of the dynamic capacity device 152, the size of the memory region 174 can change dynamically without impacting the usages of memory regions allocated for other uses.

For example, the mapped memory space 171 can have memories 173, . . . , 175 allocated respectively for the memory sub-systems 161, . . . , 163, such as submission queues 181, 185 for the memory sub-systems 161, 163 to obtain commands for execution, and completion queues 183, 187 for the memory sub-systems 161, 163 to provide completion records after execution of the commands. For example, the queues (e.g., 181, 183, 185, 187) can be used to facilitate communications with the memory sub-systems 161, . . . , 163 for storage access (e.g., according to a non-volatile memory express (NVMe) standard).

For example, a memory sub-system (e.g., 161) is allowed to retrieve commands from its submission queues (e.g., 181) but not allowed to retrieve commands from submission queues (e.g., 185) configured for other memory sub-systems (e.g., 163). Similarly, a memory sub-system (e.g., 161) is allowed to enter completion messages into its submission queues (e.g., 183) but not allowed to enter messages into completion queues (e.g., 185) configured for other memory sub-systems (e.g., 163).

The host processor 106 can send commands (e.g., read commands, write commands) to a memory sub-system (e.g., 161, or 163) by entering the commands in a submission queue (e.g., 181 or 185) configured for the memory sub-system (e.g., 161, or 163). For example, the processing device(s) 118 of the host system 102 can write a command into the submission queue 181 (e.g., in accordance with a NVMe standard); and the memory sub-system 161 can subsequently retrieve the command from the submission queue 181 (e.g., in accordance with the NVMe standard) for execution.

Optionally, the memory 173 (or 175) can be encapsulated in another dynamic capacity device offered by the controller 122 such that the capacity of the memory 173 can increase or decrease dynamically without a need for restarting.

Optionally, the mapped memory space 171, implemented according to mapping 165 in the controller 122, can have different portions allocated as host memory buffers for the memory sub-systems 161, . . . , 163.

In some implementations, a submission queue (e.g., 181) in the mapped memory space 171 is reserved for the controller 122 of the compute express link fabric 121 to send commands to operate the respective memory sub-system (e.g., 161).

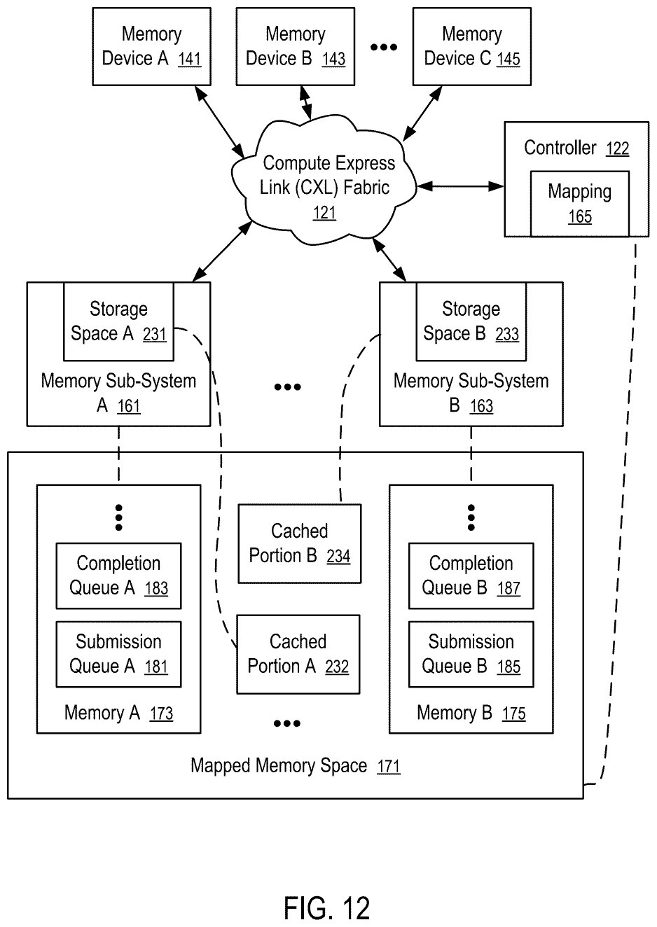

For example, the controller 122 can use a portion of the memory space 171 to cache a portion of the memory sub-system 161 (e.g., as illustrated in FIG. 12) via sending commands to the memory sub-system (e.g., 161) via the submission queue (e.g., 181) without assistance from the host processor 106. Thus, the host processor 106 can access the cached portion of the memory sub-system 161 without the need to send storage access commands to the memory sub-system (e.g., 161) using a submission queue. The controller 122 can generate the storage access commands for the host processor 106 in response to the memory access requests received in the fabric 121 from the host processor 106. Such a cached portion can be included in the memory region 174; and using such a technique, the controller 122 can also use a portion of the memory sub-system 161 to implement the persistent storage of data (e.g., 177) in at least a portion of the dynamic capacity device 152.

Thus, the dynamic capacity device 152 attached as at least a portion of the random access memory 112 in the secondary memory tier of the host processor 106 can be implemented using not only the memory resources in the memory devices 141, 143, . . . , 145 that have random access memory cells accessible via memory access protocols, but also the storage resources of the memory sub-systems 161, . . . , 163 that are configured to be accessed via storage access protocols.

For example, when a portion of the random access memory 112 used by an application running in the host processor 106 becomes cold (e.g., have not been used for a time period longer than a threshold and/or is predicted to be not used for a time period longer than a threshold), the controller can store the data (e.g., 177) of such a portion into a memory sub-system (e.g., 161 or 163) and update the mapping 165 to indicate that the data 177 of the portion of the memory region 174 is currently residing in the memory sub-system (e.g., 161 or 163). As a result, the corresponding portion of random access memory cells in the memory devices 141, 143, . . . , 145 can be freed and/or reallocated for use in a more memory-demanding application and/or by a more memory-demanding host processor.

Optionally, the host processor 106 can enter a read command in the submission queue 185 configured for the memory sub-system 163. After the memory sub-system 163 retrieves the read command from the submission queue 185, the memory sub-system 163 can execute the read command to retrieve data (e.g., 177) from its storage medium (e.g., non-volatile memory cells 114) and write the data (e.g., 177) to a memory address identified in the read command. For example, the memory address can be used to identify a location in the mapped memory space 171. Alternatively, the memory address can be used to identify a location in the main memory 124. For example, a direct memory access (DMA) engine (e.g., 135 in FIG. 3 or FIG. 4) of the memory sub-system 163 can send the data (e.g., 177) to the memory address identified in the read command without assistance from the host processor 106.

Optionally, the host processor 106 can enter a write command in the submission queue 181 configured for the memory sub-system 161. After the memory sub-system 161 retrieves the write command from the submission queue 181, the memory sub-system 161 can execute the write command by retrieving data (e.g., 177) from a memory address identified in the write command and programming its storage medium (e.g., non-volatile memory cells 114) to store the data (e.g., 177). For example, the memory address can be used to identify a location in the mapped memory space 171. Alternatively, the memory address can be used to identify a location in the main memory 124. For example, a direct memory access (DMA) engine (e.g., 135 in FIG. 3 or FIG. 4) of the memory sub-system 161 can load the data (e.g., 177) from the memory address identified in the write command without assistance from the host processor 106.

Optionally, the controller 122 can offer to attach a plurality of dynamic capacity devices 152, . . . , 154 to the host processor 106 during the boot time of the computing system 100. Each of the dynamic capacity devices 152, . . . , 154 can offer a variable capacity size and a dynamically adjustable performance level for a segment of the random access memory 112 implemented using the dynamic capacity devices 152, . . . , 154. The controller 122 can use the mapping 165 to route, via the compute express link fabric 121, memory access requests addressing the dynamic capacity devices 152, . . . , 154 to physical addresses of random access memory cells in the memory devices 141, 143, . . . , 145. Thus, different segments of the random access memory 112 can have different nominal performance levels. Optionally, the dynamic capacity devices 152, . . . , 154 can be implemented respectively using separate dynamic capacity devices (e.g., 151, . . . , 155) offered by the memory devices (e.g., 141, . . . , 143).

Alternatively, the random access memory 112 of the host processor 106 is implemented using a single dynamic capacity device 152 offered by the controller 122 and implemented using the memory resources of the memory devices 141, 143, . . . , 145 and/or the memory sub-systems 161, . . . , 163.

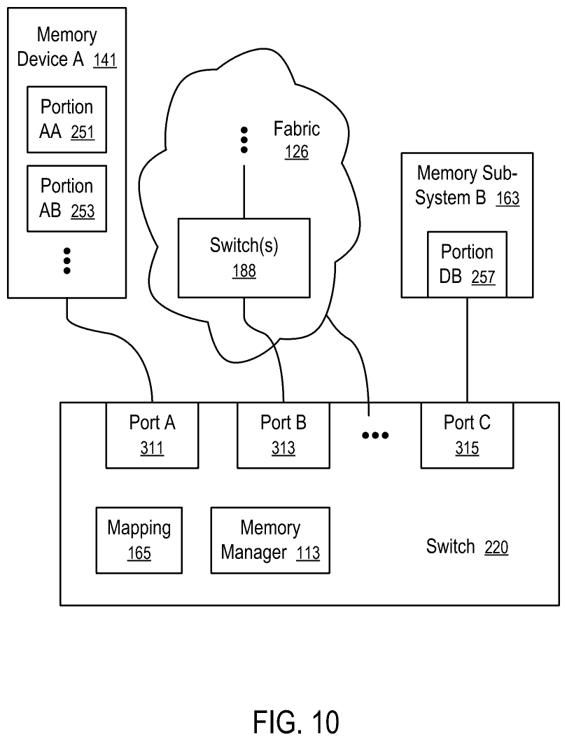

FIG. 10 shows a compute express link switch 220 configured to implement a dynamically adjustable random access memory 112 according to one embodiment. For example, the compute express link fabric switch 220 of FIG. 10 can be used to implement one or more, or each, of the switches (e.g., 221, 223 or 225) in the compute express link fabric 121 discussed above in connection with FIG. 1 to FIG. 9.

The compute express link fabric switch 220 can have a plurality of ports 311, 313, . . . , and 315. A port (e.g., 311) of the switch 220 can be connected to a memory device (e.g., 141). Such a port can be considered a device-connected port (e.g., 311). When a memory address in a memory access request is mapped to the memory device (e.g., 141) attached to the port (e.g., 311), the switch 220 routes the memory access request to the port (e.g., 311).

A port (e.g., 313) of the switch 220 can be connected to another switch (e.g., 225 or 188). Such a port (e.g., 313) can be considered a switch-connected port (e.g., 313). When a memory address in a memory access request is not mapped to the memory device (e.g., 141) attached to the port (e.g., 313), the switch 220 can route the memory access request to a switch-connected port (e.g., 313). A set of switches (e.g., 188) connected to the switch-connected port(s) (e.g., 313) of the switch 220 can be considered a fabric 126. In general, the switch 220 can have the options to route such a memory access request to more than one switch-connected port (e.g., 315) of the switch 220.

Optionally, the switch 220 can have a memory manager 113 configured to map memory access requests to its ports 311, 313, . . . , 315 according to its data of address mapping 165. Alternatively, a controller 122 configured separately from the switch 220 can provide data to instruct the switch 220 in routing the memory access requests coming into ports of the switch 220.

For example, the mapping 165 in the switch 220 and/or in the controller 122 can be configured to indicate that a portion of the memory region 174 represented by a dynamic capacity device 152 is mapped to a portion 251 in the memory device 141. For example, another portion of the memory region 174 represented by the dynamic capacity device 152 is mapped to a portion 257 in the memory sub-system 163. For example, a portion of the memory region represented by another dynamic capacity device (e.g., 154) can be mapped to a portion 253 in the memory device 141.

Since the mapping 165 can be adjusted and/or updated in the switch 220 and/or in the controller 122 without a need to restart the computing system 100 or a portion of it, the host processor 106 can request the adjustment of the capacity size of the dynamic capacity device 152, attached to implement at least a portion of its random access memory 112, without the need for restarting. When the request is received in the fabric 121, the controller 122 and/or the switch 220 can adjust the mapping 165 to implement the capacity change for the dynamic capacity device 152. Alternatively, a dynamic capacity device (e.g., 151) attached to the host processor 106 is offered by a memory device (e.g., 141); and a request to adjust its capacity size received in the fabric is routed through the fabric 121 to the memory device (e.g., 141) for execution.

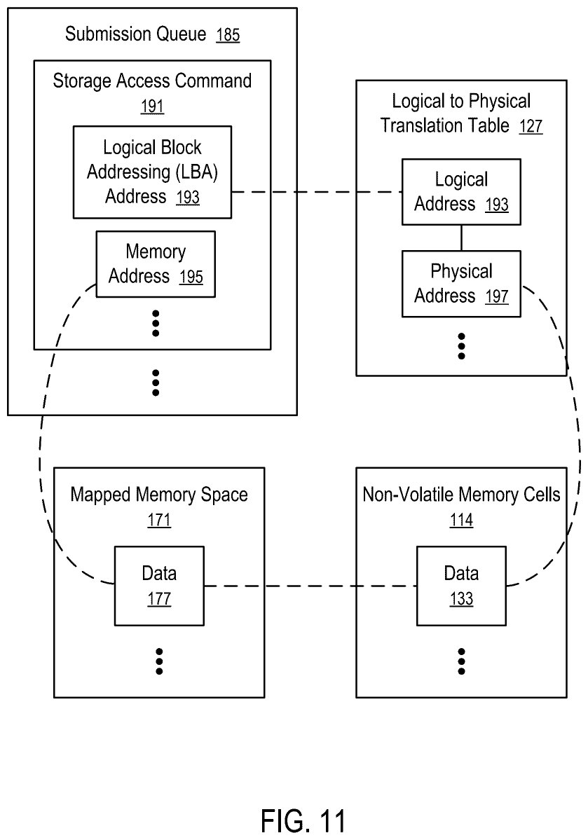

FIG. 11 shows a technique to implement a portion of a random access memory using a memory sub-system connected to a compute express link fabric according to one embodiment. For example, the random access memory 112 in the secondary memory tier of a host processor 106 provided over a compute express link fabric 121 discussed above in connection with FIG. 1 to FIG. 10 can be implemented at least in part using the resources of a memory sub-system (e.g., 161 or 163).

For example, the mapping 165 in the controller 122 of the fabric 121 and/or a switch 220 in the fabric 121 can map a portion of a dynamic capacity device 152 to a portion (e.g., 257) in a memory sub-system (e.g., 163). The dynamic capacity device 152 is attached to a host processor 106 (e.g., a processing device 118 in a host system 102, or another device 128 or 129 connected to the fabric 121). When the host processor 106 sends a memory access request into the fabric 121 to access the portion of the dynamic capacity device 152 that is mapped to the memory sub-system (e.g., 163), the controller 122 and/or the switch 220 can determine whether the portion in the memory sub-system (e.g., 163) is cached in a memory device (e.g., 141). If so, the controller 122 and/or the switch 220 can route the memory access request to the memory device (e.g., 141); otherwise, the controller 122 and/or the switch 220 can dynamically allocate memory resources from a memory device (e.g., 141) to cache the portion of the memory sub-system (e.g., 163) being accessed, and then direct the memory access request to the memory device (e.g., 141).

To cache the portion of the memory sub-system (e.g., 163), the controller 122 and/or the switch 220 can enter one or more storage access commands (e.g., 191) in a submission queue 185 configured for the memory sub-system (e.g., 163) to retrieve the data from the memory sub-system (e.g., 163) into the portion of the memory device (e.g., 141) allocated to cache the portion of the memory sub-system (e.g., 163).

A storage access command 191 in a submission queue 185 is configured to identify a logical block addressing (LBA) address 193 and a memory address 195.

The logical block addressing (LBA) address 193 identifies a logical location in a storage medium, such as non-volatile memory cells 114 of a memory sub-system 101 (e.g., 163 in FIG. 9 and FIG. 10).

The memory sub-system 101 has a logical to physical translation table 127 configured to map the LBA address 193 to the physical address 197 that can be used to address a set of memory cells among the non-volatile memory cells 114 in the memory sub-system (e.g., 163).

The memory address 195 can be configured to identify a location in the mapped memory space 171. For example, after allocating a portion 253 of the memory device 141 to implement the caching of the portion 257 of the memory sub-system 163, the controller 122 and/or the switch 220 can update their mapping to map the memory address 195 into the portion 253 in the memory device 141.

In general, with the memory address 195 and the physical address 197, the memory sub-system 101 can execute the storage access command 191 to transfer data for a read operation or a write operation.

For example, when the storage access command 191 includes an opcode for a read operation, the memory sub-system 101 can retrieve data 133 from the non-volatile memory cells 114, decode the data 133 using an error correction code (ECC) technique to obtain retrieved error-free data 177, and store the data 177 to the mapped memory space 171 at the memory address 195.

In one implementation, in response to the memory sub-system 101 storing data 177 to the memory address 195, the controller 122 of the compute express link fabric 121 maps the memory address 195 in the memory space 171 to an address in a memory device (e.g., 141, 143, or 145) connected to the fabric 121, and route to the memory device (e.g., 141, 143, or 145) the request to store the data 177. Thus, the data 177 is physically stored in the memory device (e.g., 141, 143, or 145). Alternatively, the memory address 195 can be configured to identify a location in the main memory 124; and in response, the retrieved data 177 is stored to the location in the main memory 124.

For example, when the storage access command 191 includes an opcode for a write operation, the memory sub-system 101 can load data 177 from the location in the mapped memory space 171 as specified by the memory address 195, encode the data 177 using an error correction code (ECC) technique to generate data 133, allocate non-volatile memory cells 114 at the physical address 197 to store the data 133, update the logical to physical translation table to map the logical block addressing address 193 to the physical address 197 of the allocated non-volatile memory cells 114, and program the allocated memory cells to have states representing the data 133.

In one implementation, in response to the memory sub-system 101 loading data 177 from the memory address 195, the controller 122 of the compute express link (CXL) fabric 121 maps the memory address 195 in the memory space 171 to an address in a memory device (e.g., 141, 143, or 145) connected to the fabric 121, and route to the memory device (e.g., 141, 143, or 145) the request to load data 177. Alternatively, the memory address 195 can be configured to identify a location in the main memory 124; and in response, the data 177 is loaded from the location in the main memory 124.

Using such techniques, the controller 122 and/or the switch 220 can dynamically load data from a memory sub-system (e.g., 163) into a memory device (e.g., 141) for access by a host processor 106 using random access memory cells in the memory device (e.g., 141), and write data back to a memory sub-system (e.g., 163) for persistent storage (e.g., when the memory page having the data becomes cold).

In some implementations, portions of the storage spaces of memory sub-systems 161, . . . , 163 connected to the fabric 121 are cached in the mapped memory space 171 to accelerate access to the portions of the storage spaces of the memory sub-systems 161, . . . , 163, as further discussed in connection with FIG. 12.

FIG. 12 illustrates a controller of a compute express link (CXL) fabric caching portions of memory sub-systems in the memory space provided by memory devices connected to the fabric according to one embodiment.

In FIG. 12, the memory sub-systems 161, . . . , 163 can be attached to a host system 102 having a compute express link (CXL) fabric 121 as in FIG. 2 to FIG. 5 and FIG. 9 to FIG. 10. Each of the memory sub-systems 161, . . . , 163 can be implemented in a way as in FIG. 1. The controller 122 of the fabric 121 can implement the mapped memory space 171 using the random access memory cells in the memory devices 141, 143, . . . , 145 connected to the CXL fabric 121.

For example, a memory sub-system 161 can have a storage space 231 addressable via logical block addressing (LBA) addresses (e.g., 193) as in FIG. 11 using storage access commands (e.g., 191). A portion of the storage space 231 can be cached in the mapped memory space 171 as a cached portion 232 that is physically mapped to one or more portions in the memory devices (e.g., 141, 143, and/or 145) connected to the fabric 121, in a way similar to the memory region 174 corresponding to a dynamic capacity device 152 being mapped and implemented using portions of the memory devices 141, 143, . . . , 145 connected to the fabric 121.

Similarly, a storage space 233 in the memory sub-system 163 can have a portion cached as a cached portion 234 in the mapped memory space 171. The cached portion 234 can be implemented using portions of the memory devices 141, 143, . . . , 145, in a way similar to the implementation of dynamic capacity device 152.

A host processor 106 (e.g., processing device 118 or another device 128 or 129) can optionally access the memory sub-systems 161, . . . , 163 via entering storage access commands (e.g., 191) into the submission queues (e.g., 181, 185) configured for the memory sub-systems 161, . . . , 163, or send memory access commands to the fabric 121 using memory addresses of the cached portions (e.g., 232, 234).

In some implementations, a cached portion (e.g., 232, or 234) is part of the memory region 174 (e.g., in FIG. 9) corresponding to the dynamic capacity device 152 to implement the random access memory 112 in the secondary tier memory of the host processor 106.

Optionally, the controller 122 can be configured to present the entire storage space 231 of the memory sub-system 161 as a cached portion 232 in the mapped memory space 171 such that a host processor 106 (e.g., the processing device 118, or device 128 or 129) can use the storage space 231 without using storage access commands (e.g., 191) and without using submission queues (e.g., 181) configured for the memory sub-system 161. Thus, the submission queues (e.g., 181) configured for the memory sub-system 161 can be reserved for exclusive use by the controller 122 in implementing the cached portion 232. The host processor 106 can access the cached portion 232 using memory access requests instead of storage access commands.

For example, the controller 122 can be configured to present (e.g., to the processing device(s) 118 and other devices 128, . . . . 129 connected to the fabric 121) the entire storage space 231 of the memory sub-system 161 as a portion of a random access memory in the mapped memory space 171, as if the memory sub-system 161 were a random access memory device. For example, the storage space 231 can have a capacity larger than the combined random access memory capacity of the memory devices 141, 143, . . . , 145; and thus, the mapped memory space 171 can be larger than the combined random access memory capacity of the memory devices 141, 143, . . . , 145. The controller 122 can configure its mapping 165 to map an actively used portion of the storage space 231 as a cached portion 232 that is currently mapped into portions of the memory devices 141, 143, . . . , 145, while other portions of the storage space 231 as mapped to the memory space 171 are not concurrently implemented using the random access memory in the memory devices 141, 143, . . . , 145. The memory space 171 implemented using the storage space 231 can be actually implemented using the memory devices 141, 143, . . . , 145 one portion at time. Thus, the portion of the memory space 171 implemented using the storage space 231 can have persistent storage in the memory sub-system 161, while an actively used portion of the storage space 231 is implemented (e.g., mirror or cached) in the memory devices 141, 143, . . . , 145.

For example, when the host processor 106 requests accesses to memory addresses in the mapped memory space 171 that correspond to a portion of the storage space 231, the controller 122 can determine a corresponding LBA address (e.g., 193) of the portion. If the storage space represented by the LBA address (e.g., 193) is not already cached or mirrored in the memory space 171 using random access memory of the memory devices 141, 143, . . . , 145, the controller 122 can dynamically allocate one or more portions from the memory devices 141, 143, . . . , 145, enter a read command in the submission queue 181 configured for the memory sub-system 161 to retrieve the data at the LBA address (e.g., 193) into the cached portion 232 implemented using the dynamically allocated portions of the memory devices 141, 143, . . . , 145, and route the memory access requests from the processing device(s) 118 over the fabric 121 to the memory devices 141, 143, . . . , 145.

When the controller 122 determines that the cached portion 232 is not likely to be accessed by the processing device(s) 118 in a subsequent period of time and the content of the cached portion 232 has not yet been committed into the storage space 231, the controller 122 can enter a write command in the submission queue 181 to write the data of the cached portion 232 into the memory sub-system 161. Upon receiving a completion message in the completion queue 183 that indicates the completion of the write command, the controller 122 can free the random access memory allocated from the memory devices 141, 143, . . . , 145 to implement the cached portion 232, which can then be reused to implement another cached portion of the storage space 231 of the memory sub-system 161, or a cached portion 234 of the storage space 233 of another memory sub-system 163.

Thus, the controller 122 can effectively provide a mapped memory and storage service for devices (e.g., 118, 128, 129) connected to the compute express link (CXL) fabric 121 through the use of mapping 165 to route memory access requests to the memory devices 141, 143, . . . , 145 over the CXL fabric 121 and the use of the submission queues (e.g., 181, 185) and completion queues (e.g., 183, 187) to operate the memory sub-systems 161, . . . , 163. The devices (e.g., 118, 128, 129) can access the storage spaces 231, . . . , 233 of the memory sub-systems 161, . . . , 163 via the memory devices 141, 143, . . . , 145 that are dynamically mapped by the controller 122 as proxies. Since the tasks of using message queues (e.g., 181, 183, 185, 187) to communicate with memory sub-systems (e.g., 161, 163) are offloaded to the controller 122 of the CXL fabric 121, the complexity of routines and applications running in the processing devices (e.g., 118, 128, 129) can be reduced.

Optionally, the storage spaces 231, . . . , 233 of the memory sub-systems 161, . . . , 163 can be used to implement part of the dynamic capacity devices (e.g., 152, 154) attached by the controller 122 to host processors (e.g., 106).

Optionally, the controller 122 can dynamically adjust the mapping 165 of which portions of the mapped memory space 171 are mapped to which of the memory sub-systems 161, . . . , 163 connected to the CXL fabric 121. The controller 122 can adjust the mapping 165 to balance the workloads on the memory sub-systems 161, . . . , 163 and thus improve the performance of the system.

The mapped memory and storage services allow the host processors (e.g., devices 118, 128, 129) connected to the CXL fabric 121 to access the mapped memory space 171 using memory addresses (e.g., 195) and memory access requests at a granularity of random memory access (e.g., in a unit of one byte, eight bytes, or 128 bytes), while the data stored into at least a portion of the memory space 171 is stored persistently in the storage spaces (e.g., 231, 233) of the memory sub-systems 161, . . . , 163. The host devices (e.g., 118, 128, 129) can be relieved from operations of entering commands in submission queues (e.g., 181, 185) configured for the memory sub-system 161, . . . , 163. At least a portion of the random access memory of the memory devices 141, 143, . . . , 145 can be used dynamically by the controller 122 as the cache memory for access in the storage spaces 231, . . . , 233 of the memory sub-systems 161, . . . , 163, without the host processors (e.g., devices 118, 128, 129) performing operations to manage or effectuate the caching.

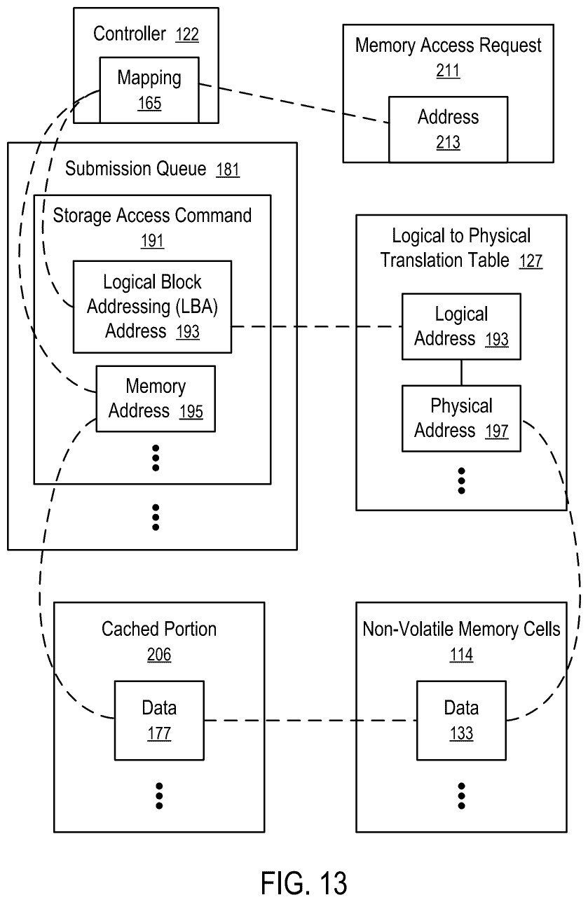

FIG. 13 illustrates communications to implement a memory access request according to one embodiment. For example, when a host processor 106 (e.g., device 118, 128, or 129) sends a memory access request 211 into the compute express link (CXL) fabric 121 in FIG. 12 to access a location in the memory space 171 that is mapped to a location in a storage space 231 in the memory sub-system 161, the memory access request 211 can be processed in a way as illustrated in FIG. 13.

In FIG. 13, when a memory access request 211 is received in the compute express link (CXL) fabric 121, the controller 122 uses its mapping 165 to determine how to route the memory access request 211 to a memory device (e.g., 141, 143, or 145) that is connected to the fabric to provide a random access memory.

Based on the mapping 165, the controller 122 can determine that the address 213 is in a portion of the mapped memory space 171 that is configured as a cached portion 206 of the storage space 231 provided by non-volatile memory cells 114 in a memory sub-system 161. Alternatively, or in combination, the controller 122 can determine that the address 213 is in a portion 206 of the mapped memory space 171 that has persistent storage implemented in the storage space 231 provided by non-volatile memory cells 114 in the memory sub-system 161.

In response, the controller 122 can determine whether the cached portion 206 is already implemented using the random access memory of the memory devices 141, 143, . . . , 145 on the fabric 121. If not, the controller can generate a storage access command 191 to implement the caching of the portion of the non-volatile memory cells 114 in the cached portion 206.

For example, the controller 122 can allocate a portion of the random access memory of the memory devices 141, 143, . . . , 145 as the cached portion 206 identified by a memory address 195 in the mapped memory space 171 such that memory access requests addressing the memory address 195 is routed to one of the memory devices 141, 143, . . . , 145 over the fabric 121. Further, based on the mapping 165, the controller 122 can determine the logical block addressing (LBA) address 193 for retrieving data 177 from the non-volatile memory cell 114 to the cached portion 206 in a way as illustrated in FIG. 11. After the memory sub-system 161 executes the storage access command 191, the controller 122 can route the memory access request 211 over the fabric 121 to a memory device (e.g., 141, 143, . . . , or 145) according to the mapping 165 from the memory address 195 to the address in the memory device (e.g., 141, 143, . . . , or 145) used to implement the cached portion 206.

Subsequently, when the controller 122 determines that the cached portion 206 is not going to be accessed for a period of time, the controller 122 can enter a write command in the submission queue 181 to write the data 177 in the cached portion 206 into the memory sub-system 161 at the logical block addressing (LBA) address 193, as in FIG. 11. Thus, the data of the cached portion 206 has persistent storage in the non-volatile memory cells 114 in the memory sub-system 161.

In some implementations, a memory manager 113 is configured in the controller 122 and/or a switch 220 of the compute express link (CXL) fabric 121 to implement the caching of portions of storage spaces 231, . . . , 233 of the memory sub-systems 161, . . . , 163, as discussed above in connection with FIG. 12 and FIG. 13.

FIG. 13 illustrates an example in which the memory address 213 in the memory access request 211 is mapped to a storage space of a memory sub-system 161. In other instances, when the memory address 213 in the memory access request 211 is specified for a dynamic capacity device 152 implemented using random access memory cells 114 of a memory device (e.g., 141, 143, or 145), the mapping 165 provides the physical memory address 195 of the random access memory cells 114 in the memory device (e.g., 141, 143, or 145). Thus, the controller 122 can cause the fabric 121 to route the memory access request 211 according to the physical memory address 195 to the memory device (e.g., 141, 143, or 145) without using the submission queue 181.

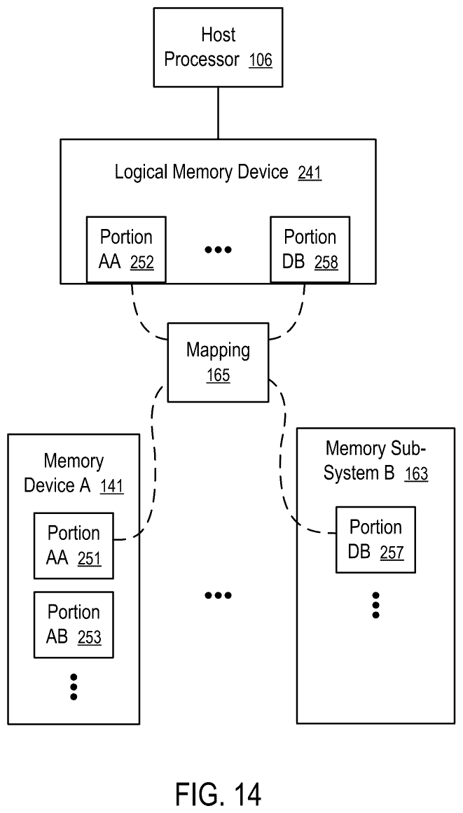

FIG. 14 shows a technique to implement a logical memory device attached to a host processor over a compute express link fabric according to one embodiment. For example, the dynamic capacity device 152 in FIG. 9 can be implemented using the technique of FIG. 14 to provide a random access memory 112 of a secondary tier memory of a host processor 106.

In FIG. 14, the logical memory device 241 is attached by a compute express link fabric 121 (e.g., as in FIG. 5) to a host processor 106. The physical memory resources of the logical memory device 241 can be allocated from one or more memory devices (e.g., 141) connected to the fabric 121, and/or from one or more memory sub-systems (e.g., 163) connected to the fabric 121. Optionally, the logical memory device 241 can be offered as a dynamic capacity device (e.g., 152) according to a standard of compute express link (CXL).

The CXL fabric 121 implements mapping 165 (e.g., via a controller 122 of the fabric 121, and/or via switches 221, 223, . . . , 225 in the fabric 121). The mapping 165 can be used to translate the memory addresses (e.g., 213) provided in memory access requests (e.g., 211) received in the fabric 121 to access the logical memory device 241 into corresponding memory addresses of random access memory cells 114 in the memory devices (e.g., 141) and/or corresponding logical block addressing addresses (e.g., 193) in the memory sub-systems (e.g., 163). Thus, a portion (e.g., 252) in the logical memory device 241 can be implemented using a portion 251 of random access memory cells 114 in the memory device 141; and another portion (e.g., 258) in the logical memory device 241 can be implemented using a portion 251 of non-volatile memory cells 114 in the memory sub-system 163.

Optionally, the logical memory device 241 is further configured to support the functions and protocols of dynamic capacity devices according to a standard for compute express link (CXL). Thus, the host processor 106 can dynamically request the change of the capacity size of the logical memory device 241 without restarting. Changes in the capacity size of the logical memory device 241 can be implemented via updating the mapping 165 without restarting.

When the host processor 106 sends a memory access request 211 to store data into, or load data from, a memory address 213 that is in the portion 252 of the logical memory device 241, the fabric 121 can use the mapping 165 to route the memory access request to the memory device 141 to access the portion 251.

When the host processor 106 sends a memory access request 211 to store data into, or load data from, a memory address 213 that is in the portion 258 of the logical memory device 241, the fabric 121 can check whether the portion 257 of the memory sub-system 163 is currently cached in a memory device connected to the fabric.

If the portion 257 of the memory sub-system 163 is currently cached in a portion (e.g., 253) of a memory device (e.g., 141), the fabric 121 can route the memory access request to the memory device (e.g., 141) to access the portion (e.g., 253) that is currently caching the portion 257 of the memory sub-system 163.

If the portion 257 of the memory sub-system 163 is not yet currently cached in any memory device connected to the fabric, the fabric 121 can dynamically allocate a portion (e.g., 253) from a memory device (e.g., 141) to implement the caching of the portion 257 of the memory sub-system 163 (e.g., using the techniques of FIG. 12 and FIG. 13).

Optionally, the allocation of memory resources from the memory device 141 can be implemented via the change of capacity size of a dynamic capacity device (e.g., 151) offered by the memory device 141. For example, when the fabric 121 is to update the mapping 165 to map the portion 252 to a portion in the memory device 141, the fabric 121 can request the dynamic capacity device 151 offered by the memory device 141 to increase its capacity size and map the portion 252 into the added portion of capacity in the dynamic capacity device 151. The memory device 141 can internally allocate a portion (e.g., 251) to implement the added portion of capacity in the dynamic capacity device 151. Similarly, to implement the caching of the portion 257 of the memory sub-system 163, the fabric 121 can further request the dynamic capacity device 151 offered by the memory device 141 to increase its capacity size and map the portion 258 into the further added portion of capacity in the dynamic capacity device 151; and the controller 122 can use the submission queue 181 to provide a storage access command 191 to load the data from the portion 257 of the memory sub-system 163 to the memory device 141.

FIG. 14 illustrates an example where portions 252, . . . , 258 of the logical memory device 241 are mapped to a memory device 141 and a memory sub-system 163. In general, portions 252, . . . , 258 of the logical memory device 241 can be mapped to one or more memory devices (e.g., 141, 143, . . . , 145), or one or more memory sub-system (e.g., 161, . . . , 163), or any combination thereof.

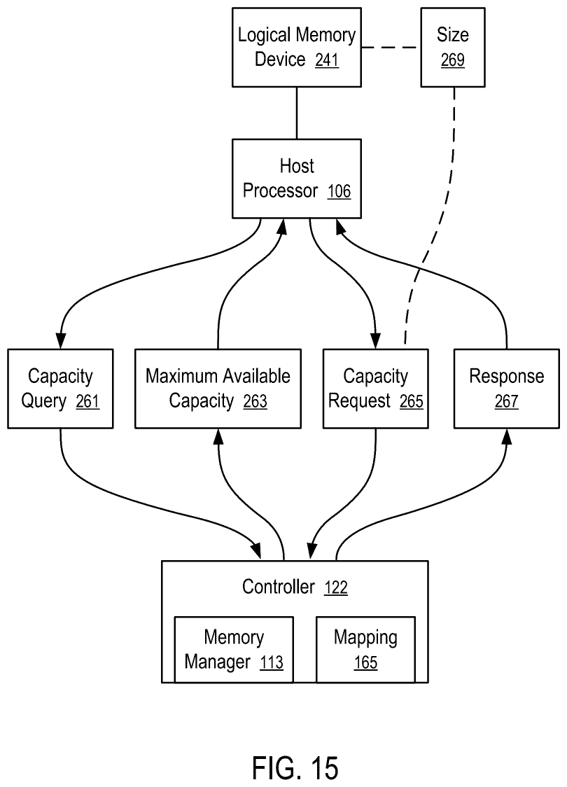

Optionally, the logical memory device 241 is configured in the fabric 121 in a way such that the host processor 106 can request the logical memory device 241 to change its capacity size and/or performance levels of the logical memory device 241 in bandwidth, latency, and/or power consumption, as in FIG. 15.

FIG. 15 shows communications of a host processor to dynamically change aspects of a logical memory device according to one embodiment. For example, the host processor 106 can communicate to adjust aspects of the logical memory device 241 of FIG. 14 in a way as illustrated in FIG. 15.

In FIG. 15, a logical memory device 241 (e.g., as implemented in FIG. 14) is attached to a host processor 106 over a compute express link fabric 121 during a boot up process of the computing system 100. After the completion of the boot up process and before a subsequent restart of the computing system 100, the host processor 106 can send a capacity query 261 to the fabric 121. The controller 122 of the fabric 121 can process the query 261 and determine a maximum currently available capacity 263 for the logical memory device 241.

For example, the controller 122 can determine, based at least in part on the current mapping 165 configured to implement a mapped memory space 171, the currently available amounts of free memory resources in the memory devices 141, 143, . . . , 145 that are currently connected to the fabric 121. The memory manager 113 can sum the currently available amounts of free memory resources to identify the maximum available capacity 263. Optionally, the currently available amounts of free memory resources can include available portions of the storage spaces 231, . . . , 233 of memory sub-systems 161, . . . , 163 that are currently connected to the fabric 121. The storage spaces 231, . . . , 233 of memory sub-systems 161, . . . , 163 can be accessed via memory access requests (e.g., 211) addressing cached portions (e.g., 232, . . . , 234) in the mapped memory space 171, as discussed in connection with FIG. 11 to FIG. 13.

Based on the maximum available capacity 263 identified by the controller 122, the host processor 106 can send a capacity request 265 to change the capacity size 269 of the logical memory device 241 to a level that is no greater than the maximum available capacity 263.

In response to the capacity request 265, the controller 122 can allocate memory resources from the memory devices 141, 143, . . . , 145 and/or the memory sub-systems 161, . . . , 163 to implement the size 269 identified in the capacity request 265. The controller 122 can update the mapping 165 to implement the logical memory device 241 (e.g., as discussed in connection with FIG. 14). After updating the mapping 165, the controller 122 can provide a response 267 indicating the completion of the processing of the capacity request 265 and/or the current size 269 of the logical memory device 241. Based on the response 267, the host processor 106 can generate a memory access request 211 that has a memory address 213 that is anywhere within the current capacity of the logical memory device 241.

FIG. 15 illustrates an example for the change of the capacity size 269 of the logical memory device 241. The communications can also be extended to request changes in performance levels of the logical memory device 241 in bandwidth, latency, and/or power consumption in a similar way.

For example, the host processor 106 can send a bandwidth query; and in response the memory manager 113 in the controller 122 identifies the maximum available bandwidth to the host processor 106. Based on the maximum available bandwidth identified by the controller 122, the host processor 106 can send a bandwidth request for a level of bandwidth of the logical memory device 241 that is no greater than the maximum available bandwidth. In response, the memory manager 113 adjusts the mapping 165 to implement the bandwidth of the logical memory device 241 identified in the host processor 106. After updating the mapping 165, the controller 122 can send a response indicating the completion of the processing of the bandwidth request from the host processor 106.

For example, the host processor 106 can send a latency query; and in response the memory manager 113 in the controller 122 identifies to the host processor 106 the maximum latency performance level that can be achieved for the logical memory device 241. Based on the maximum available latency performance level identified by the controller 122, the host processor 106 can send a latency request for a performance level of latency of the logical memory device 241 that is no greater than the maximum performance level of latency. In response, the memory manager 113 adjusts the mapping 165 to implement the latency performance level of the logical memory device 241 identified in the host processor 106. After updating the mapping 165, the controller 122 can send a response indicating the completion of the processing of the latency request from the host processor 106.

For example, the host processor 106 can send a power consumption query; and in response the memory manager 113 in the controller 122 identifies to the host processor 106 the maximum power consumption performance level that can be achieved for the logical memory device 241. Based on the maximum available power consumption performance level identified by the controller 122, the host processor 106 can send a power consumption request for a performance level of power consumption of the logical memory device 241 that is no greater than the maximum performance level of power consumption. In response, the memory manager 113 adjusts the mapping 165 to implement the power consumption performance level of the logical memory device 241 identified in the host processor 106. After updating the mapping 165, the controller 122 can send a response indicating the completion of the processing of the power consumption request from the host processor 106.

In some implementations, the capacity query 261 can include one or more performance level requirements, such as the desirable performance levels in bandwidth, latency, and/or power consumption performance level. In response, the memory manager 113 can identify the maximum available capacity 263 that can be implemented for the logical memory device 241 in a way to meet (or approximately match with) the performance levels specified in the capacity query. Subsequently, the host processor 106 can send a capacity request 265 for a capacity size 269 of the logical memory device 241 without exceeding the maximum available capacity 263. The capacity request 265 can be used to increase, decrease, or maintain the current capacity size, in view of the performance level requirements specified in the capacity query 261. In response, the memory manager 113 can update the mapping 165 to implement the capacity size 269 identified in the capacity request 265 such that the performance levels of logical memory device 241 meets (or approximately matches with) the performance levels specified in the capacity query 261. A response 267 can be sent from the controller 122 to the host processor 106 after updating the mapping 165. The response 267 can optionally include identification of nominal performance levels of the logical memory device 241 as implemented via the mapping 165.

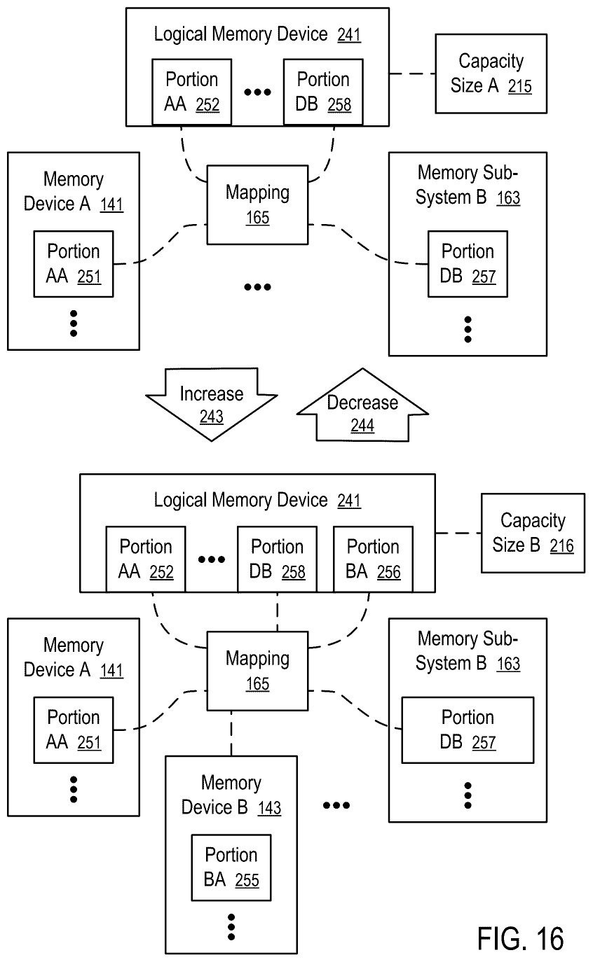

FIG. 16 shows a technique to dynamically change the capacity size of a logical memory device according to one embodiment. For example, the capacity size of the logical memory device 241 of FIG. 14 can be adjusted using the technique of FIG. 16 without restarting.

In FIG. 16, a logical memory device 241 can have a capacity size 215 when the portions 252, . . . , 258 of the logical memory device 241 are mapped, by the mapping 165 implemented in a compute express link fabric 121, into portions (e.g., 251, 257) in memory devices (e.g., 141) and/or memory sub-systems (e.g., 163) connected to the fabric 121.

The logical memory device 241 can have another capacity size 216 when the portions 252, . . . , 258, 256 of the logical memory device 241 are mapped, by the mapping 165 implemented in the compute express link fabric 121, into portions (e.g., 251, 257, 255) in memory devices (e.g., 141, 143) and/or memory sub-systems (e.g., 163) connected to the fabric 121.

As a result of the fabric 121 changing its mapping 165, the logical memory device 241 can increase 243 or decrease 244 its capacity size without a need to restart the computing system 100 in which the logical memory device 241 is currently being used.

For example, by adding the mapping of an additional portion 256 of the logical memory device 241, the capacity size 216 can be larger than the capacity size 215. By removing the mapping of the portion 256, the capacity size 215 can be smaller than the capacity size 216.

FIG. 16 illustrates an example of allocating a portion 255 from an additional memory device 143 to increase the capacity of the logical memory device 241.

Optionally, the additional portion 255 of memory resources allocated for the increase of the capacity of the logical memory device 241 can from a memory device (e.g., 141) and/or a memory sub-system (e.g., 163) that already having one or more portions (e.g., 251, 257) allocated to implement the logical memory device 241.

Optionally, the mapping 165 can be changed to move mapping destinations of portions (e.g., 252, 258) of the logical memory device 241 with or without changing the capacity of the logical memory device 241. For example, the mapping destination of the portion 258 of the logical memory device 241 can be moved between the portion 257 in the memory sub-system 163 and a portion (e.g., 255) in a memory device (e.g., 143).

When the mapping destinations are changed, the controller 122 of the fabric 121 and/or the switches (e.g., 220) in the fabric 121 can perform the operations to move or copy the data such that accessing to the same portion of the logical memory device 241 results in accessing the same data before and after the change of the mapping 165.

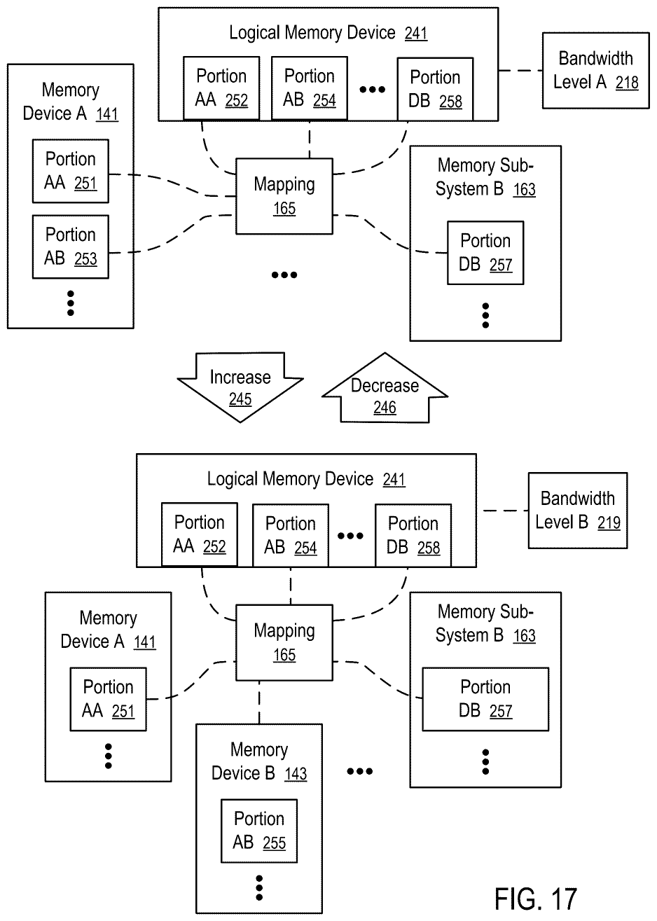

In general, the memory devices (e.g., 141, 143, . . . , 145) and memory sub-systems (e.g., 161, . . . , 163) connected to the fabric 121 have different performance levels in various aspects, such as bandwidth, latency, and power consumption. Moving the mapping destinations of portions (e.g., 252, 258) of the logical memory device 241 among the memory devices (e.g., 141, 143, . . . , 145) and memory sub-systems (e.g., 161, . . . , 163) can change and/or customize the performance levels of the logical memory device 241, as further discussed below in connection with FIG. 17 to FIG. 23.

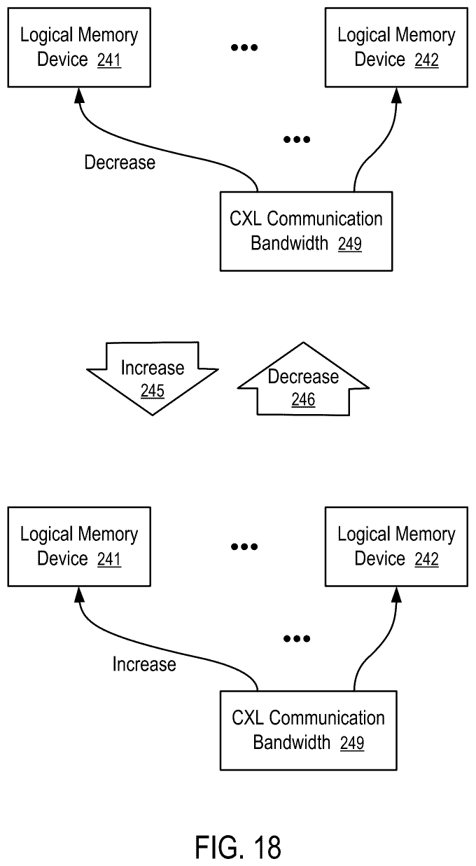

FIG. 17 and FIG. 18 show techniques to dynamically change the bandwidth of a logical memory device in servicing a host processor over express link connections according to one embodiment. For example, the bandwidth of the logical memory device 241 of FIG. 14 can be adjusted using the techniques of FIG. 17 and/or FIG. 18.

FIG. 17 illustrates an example in which the mapping destination of a portion 254 of the logical memory device 241 is changed to increase 245 or decrease 246 the bandwidth of the logical memory device 241 implemented using the mapping 165 in the compute express link fabric 121.

For example, due to the locations of the memory devices 141 and 143 on the compute express link fabric 121, the memory devices 141 and 143 can have different bandwidth levels in servicing a host processor 106, even though the memory devices 141 and 143 are manufactured to have identical memory bandwidth when accessed at their respective memory interfaces. For example, the memory device 143 can offer a higher performance level in bandwidth than the memory device 141. Thus, by changing the mapping destination of the portion 254 of the logical memory device 241 from a portion 253 in the memory device 141 to a portion 255 in the memory device 143, the bandwidth of accessing the portion 254 of the logical memory device 241 can increase; and the nominal or average bandwidth of the logical memory device 241 can increase 245 from level 218 to 219.

For example, the memory device 143 can be manufactured to have a higher level of bandwidth than the memory device 141 (e.g., due to structural differences between the memory devices 141 and 143). Thus, by changing the mapping destination of the portion 254 of the logical memory device 241 from a portion 255 in the memory device 143 to a portion 253 in the memory device 141, the bandwidth of accessing the portion 254 of the logical memory device 241 can decrease; and the nominal or average bandwidth of the logical memory device 241 can decrease 246 from level 219 to 218.

For example, the memory devices 141 and 143 can have the same bandwidth for servicing the host processor 106 over the compute express link fabric 121. The mapping destinations of the portions 252 and 254 can be split between the memory devices 141 and 143 to enable parallel/concurrent access to the portions 251 and 255; and such a mapping destination split can be implemented via the changing of the mapping to increase the access bandwidth in accessing the portions 252 and 254. To increase the opportunities for parallel/concurrent access to the memory devices 141 and 143, the portions 252 and 254 can be configured to have interleaved memory addresses in the logical memory device 241.

Further, the controller 122 of the compute express link fabric 121 and/or switches (e.g., 220) in the fabric 121 can control the allocation of communication bandwidth to logical memory devices (e.g., 241) to limit or change the bandwidth of the logical memory devices (e.g., 241) in servicing the host processor 106, as illustrated in FIG. 18.

For example, the controller 122 of the compute express link fabric 121 can use the switches (e.g., 220) in the fabric 121 to throttle the communications between the fabric 121 and the host processor 106. In FIG. 18, the total communication bandwidth 249 between the fabric 121 and the host processor 106 can be divided for allocation to the memory access communications routed between the host processor 106 and a plurality of logical memory devices 241, . . . , 242.

When the memory bandwidth of the logical memory device 241 is limited by the communication bandwidth between the fabric 121 and the host processor 106, the controller 122 can adjust the memory bandwidth of the logical memory device 241 in servicing the host processor 106 by controlling the allocation of the share of the communication bandwidth 249 allocated to the logical memory device 241.

For example, the performance level of bandwidth of the logical memory device 241 can increase 245 through increasing the share of the communication bandwidth 249 allocated to the logical memory device 241; and the performance level of bandwidth of the logical memory device 241 can decrease 246 through decreasing the share of the communication bandwidth 249 allocated to the logical memory device 241, which change can provide opportunities for the increase of bandwidth performance level of other logical memory devices (e.g., 242).

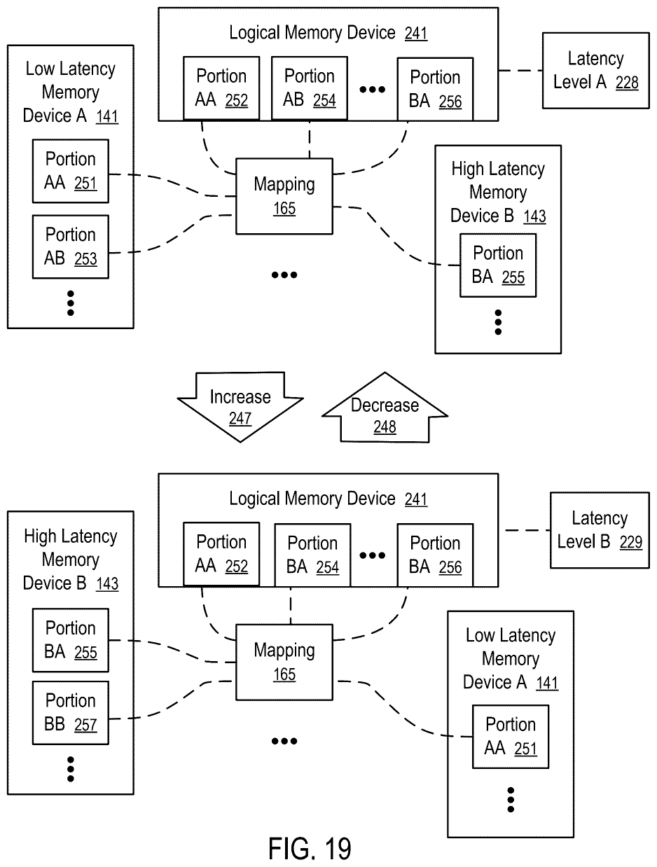

FIG. 19 to FIG. 21 show techniques to dynamically change the latency of a logical memory device in servicing a host processor over express link connections according to one embodiment. For example, the latency of the logical memory device 241 of FIG. 14 can be adjusted using the techniques of FIG. 19 and/or FIG. 21.

FIG. 19 illustrates an example in which the mapping destination of a portion 254 of the logical memory device 241 is changed to increase 247 or decrease 248 the latency level of the logical memory device 241 implemented using the mapping 165 in the compute express link fabric 121.

For example, the memory device 143 can be manufactured to have a higher level of latency than the memory device 141 (e.g., due to the use of different types of memory cells in the memory devices 141 and 143, due to different internal operating frequencies in the memory devices 141 and 143, due to different architecture implemented in the memory devices 141 and 143). Thus, by changing the mapping destination of the portion 254 of the logical memory device 241 from a portion 257 in the memory device 143 to a portion 253 in the memory device 141, the latency of accessing the portion 254 of the logical memory device 241 can decrease; and the nominal or average latency of the logical memory device 241 can decrease 248 from level 229 to 228.

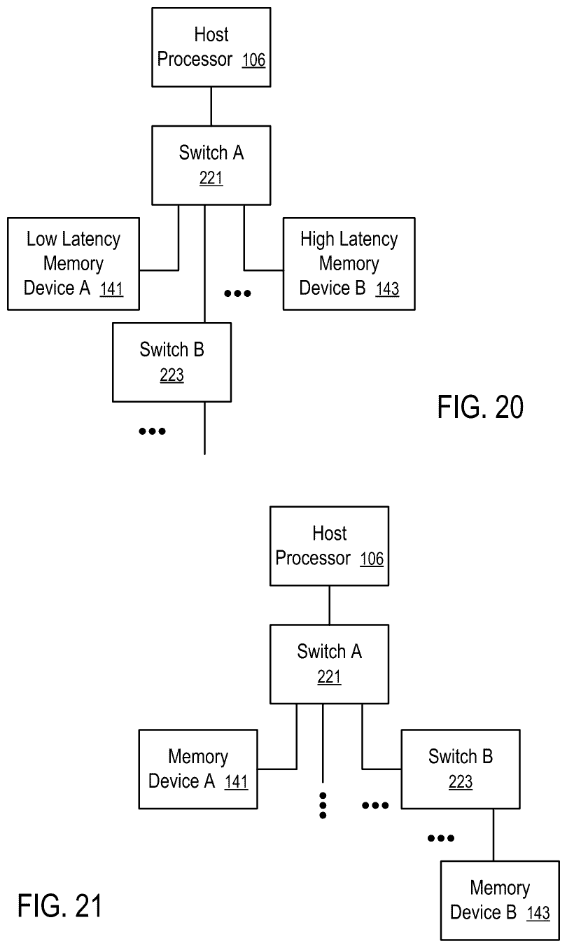

For example, the memory devices 141 and 143 can be connected via different ports of a same switch 221 to a host processor 106, as in FIG. 20. Optionally, there can be other CXL switches connected between the switch 221 and the host processor 106. The minimum communication delay between the host processor 106 and the memory device 141 is the same as the minimum communication delay between the host processor 106 and the memory device 143. Since the memory device 141 is manufactured to have a lower latency level, as being access from the switch 221, than the memory device 143, the latency level of the memory device 141 in servicing the host processor 106 is lower than the latency level of the memory device 143 in servicing the host processor 106.

For example, due to the locations of the memory devices 141 and 143 on the compute express link fabric 121, the memory device 141 can have a lower latency level than the memory device 143 in servicing a host processor 106, even though the memory devices 141 and 143 are manufactured to have identical memory access latency when accessed at their respective memory interfaces. Thus, by changing the mapping destination of the portion 254 of the logical memory device 241 from a portion 253 in the memory device 141 to a portion 257 in the memory device 143, the latency of accessing the portion 254 of the logical memory device 241 can increase; and the nominal or average latency of the logical memory device 241 can increase 247 from level 228 to 229.

For example, the memory device 141 is connected in FIG. 21 to the host processor 106 via a switch 221; and the memory device 143 is connected to the host processor 106 via at least one additional switch 223. As a result, the minimum communication delay between the host processor 106 and the memory device 141 is smaller than the minimum communication delay between the host processor 106 and the memory device 143. Since the memory devices 141 and 143 are manufactured to be substantially the same, the latency level of the memory device 141 in servicing the host processor 106 is lower than the latency level of the memory device 143 in servicing the host processor 106.

Further, the controller 122 of the compute express link fabric 121 and/or switches (e.g., 220) in the fabric 121 can control the communication delays in the fabric 121. Allocation of communication delays to a memory device (e.g., 141) can be performed by changing the priority of routing communications to or from the memory device 141. Increasing the routing delay for the memory device 143 can increase the latency of the memory device 143 in servicing the host processor 106 over the fabric 121, which creates opportunities to reduce communication delays to another memory device (e.g., 141) in servicing the host processor 106 over the fabric 121 and thus reduce the latency of the memory device (e.g., 141).

For example, the memory device 143 can be manufactured to have a same level of latency as the memory device 141 and connected to have the same minimum communication delay in communications through the fabric 121 with the host processor 106 (e.g., connected in a way as in FIG. 20). However, when the communication traffic in the fabric 121 is heavy, the fabric 121 can prioritize the communications to or from the memory device 141 over the memory device 143. As a result, the memory device 141 has a lower latency than the memory device 143.

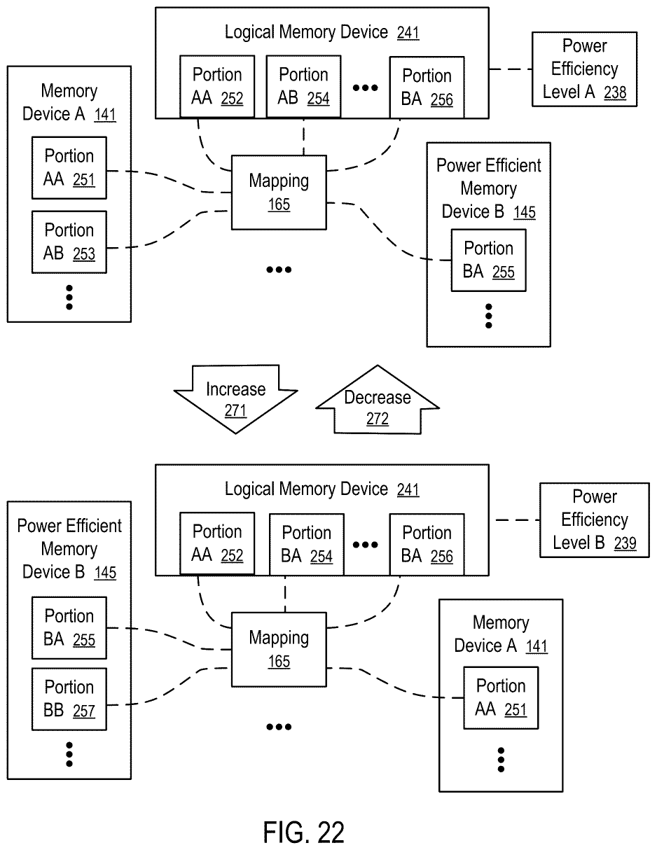

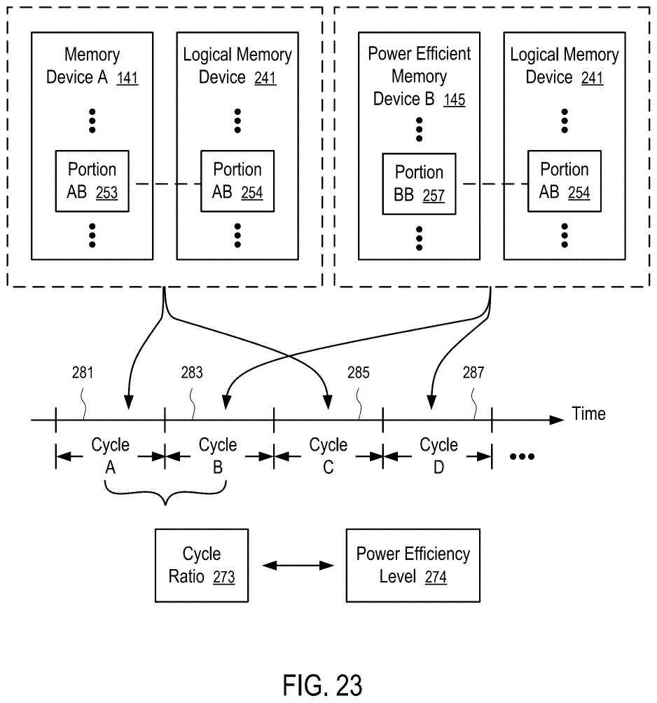

FIG. 22 and FIG. 23 show techniques to dynamically change the power consumption level of a logical memory device in servicing a host processor over express link connections according to one embodiment. For example, the power consumption level of the logical memory device 241 of FIG. 14 can be adjusted using the techniques of FIG. 22 and/or FIG. 23.

FIG. 22 illustrates an example in which the mapping destination of a portion 254 of the logical memory device 241 is changed to increase 271 or decrease 272 the power efficiency level of the logical memory device 241 implemented using the mapping 165 in the compute express link fabric 121.

For example, the memory device 145 can be manufactured to have a lower level of power consumption for operation (and thus more power efficient) than the memory device 141 (e.g., due to the use of different types of memory technologies in the memory devices 141 and 145).

By changing the mapping destination of the portion 254 of the logical memory device 241 from a portion 253 in the memory device 141 to a portion 257 in the memory device 145, the power efficiency of operating the portion 254 of the logical memory device 241 can increase; and the nominal or average power efficiency of the logical memory device 241 can increase 271 from level 238 to 239.

Similarly, by changing the mapping destination of the portion 254 of the logical memory device 241 from a portion 257 in the memory device 145 to a portion 253 in the memory device 141, the power efficiency of operating the portion 254 of the logical memory device 241 can decrease; and the nominal or average power efficiency of the logical memory device 241 can decrease 272 from level 239 to 238.

Optionally, the mapping destination of the portion 254 can be changed periodically such that over a period of time, the nominal or average power efficiency of the logical memory device 241 over a period of time approaches a target power efficiency level, as illustrated in FIG. 23.

FIG. 23 illustrates an example of changing the mapping destination of a portion 254 of the logical memory device 241 periodically to customize the power consumption in the operations of the memory portion 254.

For example, in alternating operation cycles (e.g., 281, 285, . . . ), the mapping 165 in the CXL fabric 121 is configured to map the portion 254 of the logical memory device 241 to the portion 253 in the memory device 141; and in intervening operation cycles (e.g., 283, 287, . . . ), the mapping 165 in the CXL fabric 121 is configured to map the portion 254 of the logical memory device 241 to the portion 257 in the power efficient memory device 145. Thus, over a period of time of a plurality of cycles, the power efficiency of the portion 254 in the logical memory device 241 is between the power efficiency of the portion 253 in the memory device 141 and the power efficiency of the portion 257 in the power efficient memory device 145.

When the cycle ratio 273 between the adjacent operation cycles (e.g., 281 and 283) is equal to one, the power efficiency level 274 of the portion 254 in the logical memory device 241 is substantially equal to the average of the power efficiency of the memory device 141 and the power efficiency of the power efficient memory device 145. Adjusting the ratio 273 can be used to move the power efficiency level 274 of the portion 254 in the logical memory device 241 between the power efficiency of the memory device 141 and the power efficiency of the power efficient memory device 145.

However, the performance level of the power efficient memory device (e.g., 145) can be lower than the memory device 141 in other aspects, such as latency and/or bandwidth. Thus, increasing the power efficiency level through the mapping change as in FIG. 22 can potentially reduce the performance level of the logical memory device 241 in latency and/or bandwidth.

Optionally, the technique of FIG. 23 is also used to adjust the bandwidth and/or latency of a portion (e.g., 254) of the logical memory device.

For example, by alternating the mapping destination of the portion 254 of the logical memory device 241 between a portion 253 of a low latency memory device 141 and a portion 257 of a high latency memory device 143 (e.g., memory devices 141 and 143 as in FIG. 19) in a number of operation cycles (e.g., 281, 283, 285, 287, . . . ), the latency level of the portion 254 of the logical memory device 241 can be customized based on the cycle ratio 273 to a level between the latency level of the low latency memory device 141 and the latency level of the high latency memory device 143.

For example, by alternating the mapping destination of the portion 254 of the logical memory device 241 between a portion 253 of a memory device 141 and a portion 255 of another memory device 143 (e.g., memory devices 141 and 143 as in FIG. 17) in a number of operation cycles (e.g., 281, 283, 285, 287, . . . ), the bandwidth level of the portion 254 of the logical memory device 241 can be customized based on the cycle ratio 273 to a level between the bandwidth levels of the memory devices 141 and 143 in servicing the host processor 106.

When the mapping destination of a portion (e.g., 254) of the logical memory device 241 is changed by the controller 122 and/or the fabric 121, the controller 122 and/or the fabric 121 can copy autonomously the data of the portion (e.g., 254) from the old destination to the new destination without assistance from the host processor 106

In some implementations, the techniques of FIG. 17 to FIG. 23 are used in combination to adjust the mapping 165 in a way such that the performance levels of the logical memory device 241 in bandwidth, latency, and/or power consumption meet, or approximately equal to, the performance levels specified by the host processor 106 (e.g., as specified in a capacity query 261, a capacity request 265, or another request).

For example, a performance difference measure can be configured as the cartesian distance between a requested performance point in a space of capacity, latency, and/or bandwidth, and a performance point of a logical memory device 241, as implemented via the mapping 165, in the same space of capacity, latency, and/or bandwidth. Optionally, the space for the measurement of a performance difference can be based on normalized and/or weighted performance levels in capacity, latency, bandwidth, and/or power consumption.

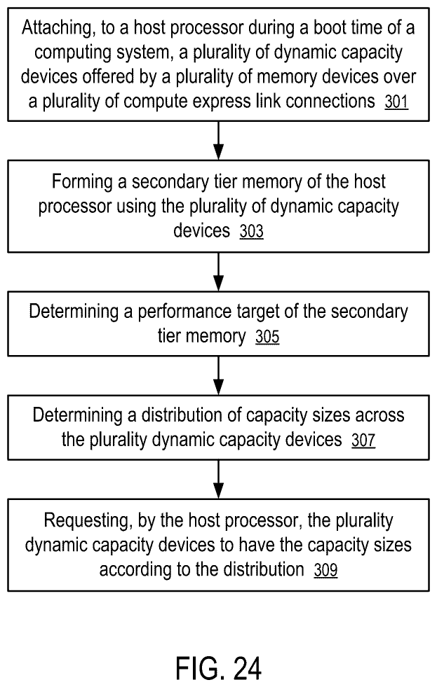

FIG. 24 shows a method to implement a dynamically adjustable secondary tier memory attached via compute express link connections to a host processor according to one embodiment. For example, the method of FIG. 24 can be implemented in the memory managers 113 of the computing system 100 of FIG. 1 to adjust the random access memory 112 using dynamic capacity devices offered by memory devices as in FIG. 2 to FIG. 4 and FIG. 6 to FIG. 8.

For example, the computing system 100 can include: a compute express link fabric 121 (e.g., as in FIG. 5) having a plurality of compute express link connections; a plurality of memory devices (e.g., 141, 143, . . . , 145) configured to provide at least a plurality of dynamic capacity devices (e.g., 151, 152, 154, 155) over the compute express link fabric 121; and a plurality of host processors (e.g., 106, such as device 118, 128, or 129) connected to the compute express link fabric 121.

The plurality of dynamic capacity devices (e.g., 151, 152, 154, 155) are attached to a host processor 106 among the plurality of host processors (e.g., device 118, 128, or 129) during a boot time of the system to form a secondary tier memory.

The host processor 106 is configured to, between the boot time and a subsequent restart of the system: identify, based on applications running in the host processor 106, a requirement for an aspect of the secondary tier memory (e.g., capacity, bandwidth, latency, power and/or efficiency); and request at least one of the plurality of dynamic capacity devices to change capacity such that the aspect of the secondary tier memory meets the requirement.

For example, the aspect can be capacity, bandwidth, latency, or power consumption, or any combination thereof. The compute express link fabric 121 can further include at least one compute express link switch (e.g., 221, 223, 225; 220). The plurality of dynamic capacity devices (e.g., 151, 152, 154, 155) can include one dynamic capacity device provided by each of the plurality of memory devices. Each of the plurality of memory devices is configured to offer more than one dynamic capacity devices. At least some of the plurality of memory devices (e.g., 141, 143, . . . , 145) are configured to have different performance levels in servicing the host processor 106 over the compute express link fabric 121.

For example, the host processor 106 can determine a plurality of capacity sizes for the plurality dynamic capacity devices (e.g., 151, 152, 154, 155) respectively to implement the requirement for the aspect, such as capacity, bandwidth, latency, or power consumption, or any combination thereof. The determining of the plurality of capacity sizes can include reducing or minimizing a cartesian distance between a performance point of the secondary tier memory in a memory characteristics space and a performance target in the same space, which can include at least a dimension of normalized and/or weighted bandwidth and a dimension of normalized and/or weighted latency.

For example, a memory manager 113 can be configured in the host processor 106, the fabric 121, and/or the host system 102 to perform the method of FIG. 24.

At block 301, the method of FIG. 24 includes attaching, to a host processor 106 during a boot time of a computing system 100, a plurality of dynamic capacity devices (e.g., 151, 152, 154, 155) offered by a plurality of memory devices (e.g., 141, 143, . . . , 145) over a plurality of compute express link connections.

For example, the plurality of dynamic capacity devices (151, 152, 154, 155) can include one dynamic capacity device (e.g., 151) provided by each memory device (e.g., 141) of the plurality of memory devices (e.g., 141, . . . , 143).

For example, each memory device (e.g., 141) of the plurality of memory devices (e.g., 141, . . . , 143) can be configured to offer more than one dynamic capacity devices (e.g., 151, 153, . . . ).

Attaching a dynamic capacity device (e.g., 151) from a memory device (e.g., 141) to a host processor (e.g., 106) allows the host processor (e.g., 106) to dynamically change the amount of memory resources allocated from the memory device (e.g., 141); and attaching a dynamic capacity device (e.g., 151) from each memory device (e.g., 141) in a plurality of memory devices (e.g., 141, . . . , 143) to the host processor (e.g., 106) provides the host processor (e.g., 106) with flexibility of dynamically changing the amounts of memory resources allocated from the memory devices (e.g., 141, . . . , 143).

At block 303, the method includes forming a secondary tier memory (e.g., random access memory 112) of the host processor 106 using the plurality of dynamic capacity devices (e.g., 151, 152, 154, 155).

At block 305, the method includes determining a performance target 158 of the secondary tier memory (e.g., random access memory 112).

For example, the performance target 158 can be determined for the applications currently running in the host processor 106 and thus can reflect the memory demand of the running applications.

For example, the performance target 158 can be based at least in part on a performance level of the secondary tier memory in latency, bandwidth, or power consumption, or any combination thereof in servicing, over the compute express link fabric 121, the applications running in the host processor 106.

At block 307, the method includes determining a distribution of capacity sizes (e.g., 201, . . . , 203) across the plurality dynamic capacity devices (e.g., 151, . . . , 155).

For example, the plurality of memory devices (e.g., 141, . . . , 143) can have different performance levels (e.g., in bandwidth, latency, and/or power consumption level) in servicing the host processor 106 over the compute express link fabric 121. Changing the combination of the capacity sizes (e.g., 201, . . . , 203) across the plurality dynamic capacity devices (e.g., 151, . . . , 155) used to implement the secondary tier memory of the host processor 106 can customize the performance level of the secondary tier memory of the host processor 106 according to the performance target 158 specified by the host processor 106.

For example, the determining of the distribution at block 307 can include reducing or minimizing a cartesian distance between a performance point of the secondary tier memory in a space of capacity, latency, and bandwidth and the performance target 158 in the same space of capacity, latency, and bandwidth. Optionally, the space can be configured to span over normalized capacity, normalized latency, and normalized bandwidth.

At block 309, the method includes requesting, by the host processor 106, the plurality dynamic capacity devices (e.g., 151, . . . , 155) to have the capacity sizes (e.g., 201, . . . , 203) according to the distribution.

For example, the requesting of the plurality dynamic capacity devices (e.g., 151, . . . , 155) to have the capacity sizes (e.g., 201, . . . , 203) can be communicated in accordance with a standard of compute express link.

For example, the plurality of memory devices (e.g., 123; or 141, 143, . . . , 145) are connected via a compute express link fabric 121 to the host processor 106; and the dynamic capacity devices (e.g., 151, . . . , 155) can be configured to implement the capacity sizes (e.g., 201, . . . , 203) without causing the computing system 100, the processor 106, and/or the compute express link fabric 121 containing the compute express link connections to restart.

Optionally, the dynamic capacity devices connected to implement the secondary tier memory of the host processor 106 includes a dynamic capacity device (e.g., 152) offered by the controller 122 of the fabric 121 and implemented via an address mapping 165 configured in the fabric 121, as in FIG. 9 to FIG. 14. The processor 106 can request the dynamic capacity device (e.g., 152) to change not only its capacity, but also its latency, bandwidth, and/or power efficiency level, as in FIG. 15 to FIG. 23.

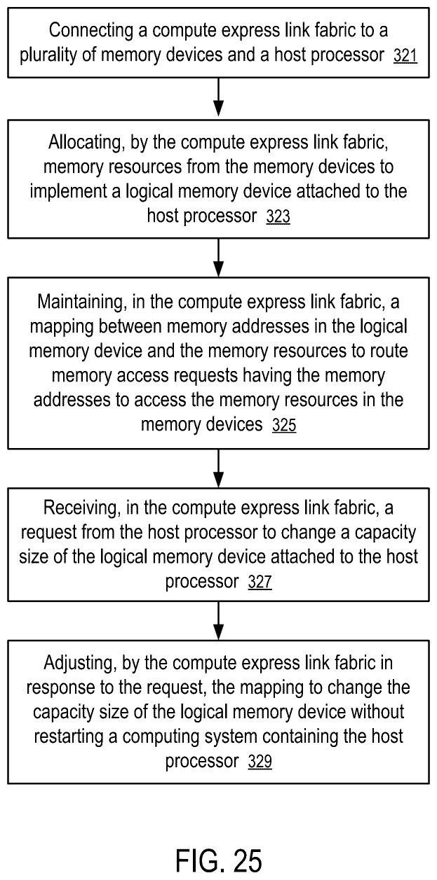

FIG. 25 shows a method to dynamically change the capacity size of a random access memory in a secondary tier memory of a host processor according to one embodiment. For example, the method of FIG. 25 can be implemented in the memory managers 113 of the computing system 100 of FIG. 1 to adjust the random access memory 112 using dynamic capacity devices offered by a compute express link fabric controller 122 and/or switch 220 as in FIG. 2 to FIG. 5 and FIG. 9 to FIG. 14. For example, the adjustments can be implemented using the techniques of FIG. 15 and/or FIG. 16.

For example, the computing system 100 can include: a compute express link fabric 121 (e.g., as in FIG. 5) having a controller 122; a plurality of memory devices (e.g., 141, 143, . . . , 145) connected to the compute express link fabric 121; and a plurality of host processors (e.g., devices 118, 128, 129) connected to the compute express link fabric 121. The controller 122 can be configured to: offer and/or attach, at a boot time of the system 101, a logical memory device (e.g., 241, dynamic capacity device 152) to a host processor (e.g., 106) among the plurality of host processors (e.g., devices 118, 128, 129). Further, the controller 122 is configured to allocate memory resources (e.g., portions 251, 255) from the memory devices (e.g., 141, 143) to implement the logical memory device (e.g., 241) using a mapping 165 between memory addresses (e.g., 213) in the logical memory device (e.g., 241) and the memory resources (e.g., portions 251, 255) to route memory access requests (e.g., 211) having the memory addresses (e.g., 213) to access the memory resources in the memory devices (e.g., 141, 143). Further, the controller 122 can be configured to receive a request (e.g., 265) from the host processor 106 to change a capacity size (e.g., 269) of the logical memory device (e.g., 241) attached to the host processor 106 and, in response to the request 265, adjust the mapping 165 to change the capacity size (e.g., 269) of the logical memory device 241 without restarting the computing system 100, the host processor 106, and/or the fabric 121.

For example, the compute express link fabric 121 can have a plurality of compute express link switches (e.g., 221, 223, . . . , 225); and the memory resources (e.g., portions 251, 255) can be allocated from more than one of the memory devices (e.g., 141, 143) to implement the logical memory device 241. Optionally, the request (e.g., 265) can be communicated in accordance a standard for compute express link (CXL); and the logical memory device 241 can be attached to the host processor 106 as a dynamic capacity device 152.

For example, a memory manager 113 can be configured in the fabric 121, the controller 122 and/or the host system 102 to perform the method of FIG. 25.

At block 321, the method of FIG. 25 includes connecting a compute express link fabric 121 to a plurality of memory devices 141, 143, . . . , 145 and a host processor 106 (e.g., as in FIG. 5).

At block 323, the method includes allocating, by the compute express link fabric 121, memory resources (e.g., portions 251, 253 of random access memory cells 114) from the memory devices 141, 143, . . . , 145 to implement a logical memory device 241 attached to the host processor 106 (e.g., as in FIG. 9 and/or FIG. 14).

For example, the memory resources (e.g., portions 251, 255 of random access memory cells 114) can be allocated from more than one of the memory devices (e.g., 141, 143, . . . , 145) to implement the logical memory device 241.

At block 325, the method includes maintaining, in the compute express link fabric 121, a mapping 165 between memory addresses (e.g., 213) in the logical memory device 241 and the memory resources (e.g., portions 251, 253 of the memory devices 141, 143, . . . , 145) to route memory access requests (e.g., 211) having the memory addresses (e.g., 213) to access the memory resources in the memory devices 141, 143, . . . , 145.

At block 327, the method includes receiving, in the compute express link fabric 121, a request (e.g., 265) from the host processor 106 to change a capacity size (e.g., 269) of the logical memory device 241 attached to the host processor 106.

At block 329, the method includes adjusting, by the compute express link fabric 121 in response to the request 265, the mapping 165 to change the capacity size (e.g., 269) of the logical memory device 241 without restarting a computing system 100 containing the host processor 106.

For example, the request 265 can be communicated in accordance a standard for compute express link (CXL); and the logical memory device 241 can be attached to the host processor 106 as a dynamic capacity device 152 during the boot time of the computing system 100.

Optionally, the request 265 can include performance level requirements for the logical memory device 241, such as a memory bandwidth requirement, a memory access latency requirement, and/or a memory power efficiency requirement. The mapping 165 can be adjusted to implement not only the capacity requirement specified by the host processor 106, but also other requirements specified by the host processor 106, such as a memory bandwidth requirement, a memory access latency requirement, and/or a memory power efficiency requirement.

Optionally, the method of FIG. 25 can further include: receiving, in the compute express link fabric 121 and from the host processor 106, a capacity query 261 for the logical memory device 241 prior to the request 265; determining, by the compute express link fabric 121 in response to the capacity query 261, a maximum amount of memory resources in the memory devices 141, 143, . . . , 145 that are currently available for allocation to the logical memory device 241; and identifying, to the host processor by the compute express link fabric based on the amount and in response to the capacity query 261, a maximum available capacity 263 of the logical memory device 241. Thus, the host processor 106 can make the request 265 for a capacity size 269 that is no larger than the maximum available capacity 263 and that can be implemented via allocating currently available memory resources from the memory devices 141, 143, . . . , 145 to the logical memory device 241.

Optionally, the capacity query 261 can include performance level requirements specified by the host processor 106 for the logical memory device 241, such as a memory bandwidth requirement, a memory access latency requirement, and/or a memory power efficiency requirement. The maximum available capacity 263 is determined within the constraints of the performance level requirements specified by the host processor 106.

For example, the requested capacity size can be larger than a current capacity size of the logical memory device 241 at a time when the request 265 is received in the compute express link fabric 121; and additional memory resources can be allocated from the memory devices 141, 143, . . . , 145 to implement the logical memory device 241 and thus to increase 243 of the capacity of the logical memory device 241.

Alternatively, the requested capacity size can be smaller than a current capacity size of the logical memory device 241 at a time when the request 265 is received in the compute express link fabric 121; and a portion of the memory resources currently being allocated to implement the logical memory device 241 can be freed to decrease 244 the capacity of the logical memory device 241. The freed memory resources can be used to implement logical memory devices attached to other host processors (e.g., devices 118, 128, 129).

Optionally, the method of FIG. 25 can further include: generating, by the compute express link fabric 121 after the completion of the adjusting at block 329, a response 267 to the request 265.

Optionally, the request 265 and/or the capacity query 261 can include a performance target 158 specified by the host processor 106. The performance target 158 can be different from a previously requested performance target. In some instances, the requested capacity size can be the same as the current capacity size of the logical memory device 241 at a time when the request 265 is received in the compute express link fabric 121; and thus, the request 265 can be sent by the host processor 106 to request a change in the performance target of the logical memory device 241 without changing the capacity of the logical memory device 241. Optionally, the request 265 can be configured to change the capacity of the logical memory device 241 without changing the performance target previously requested for the logical memory device 241.

For example, the performance target 158 can include a requested level of bandwidth of the logical memory device 241 in servicing the host processor 106 over the fabric 121, a requested level of latency of the logical memory device 241 in servicing the host processor 106 over the fabric 121, and/or a requested level of power efficiency of the logical memory device 241.

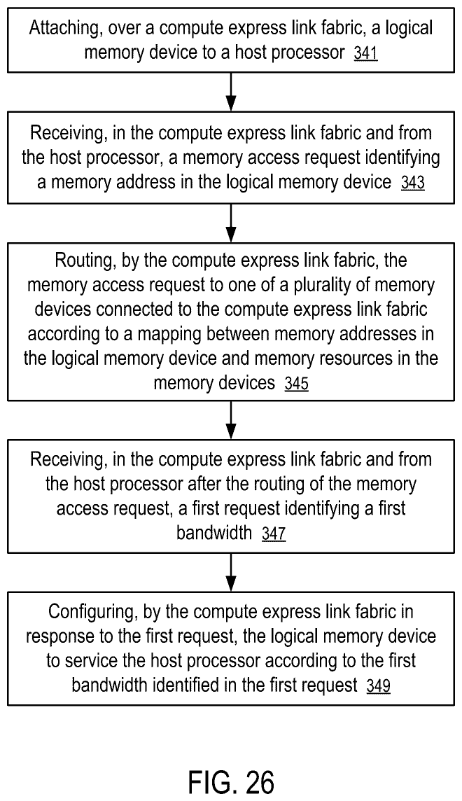

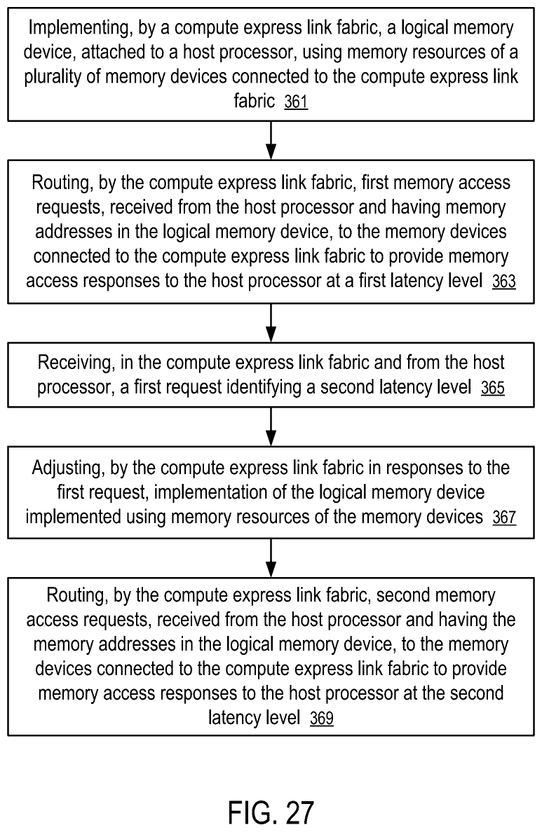

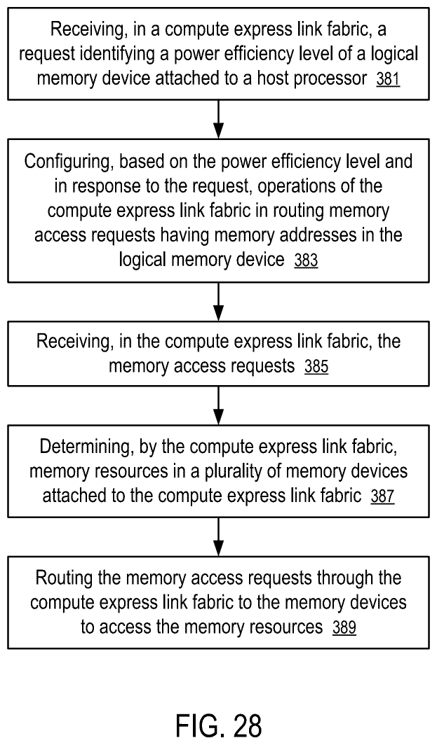

When the capacity request 265 is configured to change a performance level of the logical memory device 241 in bandwidth, latency, and/or power efficiency, the method of FIG. 25 can be used in combination with FIG. 26, FIG. 27, and/or FIG. 28.

FIG. 26 shows a method to dynamically change the performance level in bandwidth of a random access memory in a secondary tier memory of a host processor according to one embodiment. For example, the method of FIG. 26 can be implemented in the memory managers 113 of the computing system 100 of FIG. 1 to adjust the random access memory 112 using dynamic capacity devices offered by a compute express link fabric controller 122 and/or switch 220 as in FIG. 2 to FIG. 5 and FIG. 9 to FIG. 14. For example, the adjustments can be implemented using the techniques of FIG. 17 and/or FIG. 18.

For example, the computing system 100 can include: a compute express link fabric 121 (e.g., as in FIG. 5) having a controller 122; a plurality of memory devices 141, 143, . . . , 145 connected to the compute express link fabric 121; and a plurality of host processors (e.g., devices 118, 128, 129) connected to the compute express link fabric 121. The controller 122 is configured to instruct the compute express link fabric 121 to route a memory access request 211, having a memory address 213 identified in a logical memory device 241 attached over the compute express link fabric 121 to a host processor 106, among the plurality of host processors (e.g., devices 118, 128, 129), to one of the memory devices 141, 143, . . . , 145 according to a mapping 165 between memory addresses (e.g., 213) in the logical memory device 241 and memory resources (e.g., at memory address 195 of random access memory cells 114) in the memory devices 141, 143, . . . , 145. The controller 122 is further configured to: receive, via the compute express link fabric 121 and from the host processor 106 after the memory access request 211, a first request (e.g., 265) identifying a first bandwidth level; and configure, in response to the first request (e.g., 265), the logical memory device 241 to service the host processor 106 according to the first bandwidth level identified in the first request (e.g., 265). For example, the controller 122 can change, via adjusting the mapping 165, a bandwidth of the logical memory device 241 in servicing the host processor 106 over the compute express link fabric 121 at the bandwidth level requested by the processor 106 via the request (e.g., 265) without restarting the computing system 100, the host processor 106, and/or the fabric 121. For example, a memory manager 113 can be configured in the fabric 121, the controller 122, and/or the host system 102 to perform the method of FIG. 26.

At block 341, the method of FIG. 26 includes attaching, over a compute express link fabric 121 (e.g., as in FIG. 5), a logical memory device 241 to a host processor 106 (e.g., as in FIG. 14).

At block 343, the method includes receiving, in the compute express link fabric 121 and from the host processor 106, a memory access request 211 identifying a memory address 213 in the logical memory device 241.

At block 345, the method includes routing, by the compute express link fabric 121, the memory access request 211 to one of a plurality of memory devices 141, 143, . . . , 145 (e.g., at a memory address 195) connected to the compute express link fabric 121 according to a mapping 165 between memory addresses (e.g., 213) in the logical memory device 241 and memory resources in the memory devices 141, 143, . . . , 145 at physical memory addresses (e.g., 195) of random access memory cells 114 in the memory devices 141, 143, . . . , 145.

At block 347, the method includes receiving, in the compute express link fabric 121 and from the host processor 106 after the routing of the memory access request 211, a first request (e.g., 265) identifying a first bandwidth (e.g., level 218 or 219).

At block 349, the method includes configuring, by the compute express link fabric 121 in response to the first request (e.g., 265), the logical memory device 241 to service the host processor 106 according to the first bandwidth (e.g., level 218 or 219) identified in the first request (e.g., 265).

Optionally, after the first request (e.g., 265), the method of FIG. 26 can further include the host processor 106 sending a second request to change the capacity, latency, and/or power efficiency of the logical memory device 241.

For example, the host processor 106 can send the first request 265 to increase, to the first bandwidth identified in the first request 265, a nominal bandwidth of the logical memory device 241 in servicing the host processor 106.

For example, the configuring of the logical memory device 241 at block 349 can include: adjusting the mapping 165 to change a bandwidth of the logical memory device 241 in servicing the host processor 106 over the compute express link fabric 121.

For example, prior to the configuring at block 349, the mapping 165 is configured to map a region of memory addresses (e.g., portion 254) in the logical memory device 241 to a first memory device (e.g., 141) among the plurality of memory devices 141, 143, . . . , 145; and after the configuring at block 349, the mapping 165 is configured to map the region of memory addresses (e.g., portion 254) in the logical memory device to a second memory device (e.g., 143), different from the first memory device (e.g., 141), among the plurality of memory devices 141, 143, . . . , 145. Thus, the configuring at block 349 causes the bandwidth of the logical memory device 241 in servicing the host processor 106 to change from level 218 to level 219.

For example, a bandwidth of the second memory device 143 in servicing the host processor 106 over the compute express link fabric 121 is closer to the first bandwidth specified in the request 265 than a bandwidth of the first memory device 141 in servicing the host processor 106 over the compute express link fabric 121. Thus, changing the mapping destination of the portion 254 of the logical memory device 241 causes the bandwidth of the logical memory device 241 to be closer to the first bandwidth specified by the host processor in the request 265.

For example, the bandwidth of the second memory device 143 is above the first bandwidth; the bandwidth of the first memory device 141 is below the first bandwidth; and the first request 265 causes the compute express link fabric 121 to increase 245 a nominal bandwidth of the logical memory device.

The configuring at block 349 can be performed without restarting the computing system 100, the host system 102, and/or the host processor 106. Optionally, the configuring at block 349 can be performed without changing a capacity size 269 of the logical memory device 241.

In some implementations, the first memory device 141 and the second memory device 143 have a substantially same maximum bandwidth; and the compute express link fabric 121 can adjust, based on the first bandwidth identified in the first request 265, a share of communication bandwidth allocated to the second memory device 143, among the plurality of memory devices 141, 143, . . . , 145, for communicating over the compute express link fabric 121 such that the resulting level 219 of bandwidth of the logical memory device 241 in servicing the host processor 106 is at or above the first level specified by the host processor 106 in the first request 265.

When the mapping destination of the portion 254 of the logical memory device 241 is changed, the compute express link fabric 121 can communicate, without assistance from the host processor 106, data stored in the portion 254 (e.g., the region of memory addresses) in the logical memory device 241 from the first memory device 141 to the second memory device 143.

Optionally, the first request (e.g., 265) can be configured to decrease 246 the bandwidth requirement for the logical memory device 241; and the configuring at block 349 can be performed to free up a portion of the bandwidth allocated to the logical memory device 241. The freed portion of the bandwidth can be used by other host processors (e.g., devices 118, 128, 129) connected to the compute express link fabric 121.

Optionally, the configuring at block 349 is performed to not only change the bandwidth of the logical memory device 241 in servicing the host processor 106, but also the capacity, latency, and/or power efficiency of the logical memory device 241 according to the requirements provided by the host processor 106 in the first request 265. The method of FIG. 26 can be used in combination with the methods of FIG. 24 to FIG. 25, FIG. 27, and/or FIG. 28.

FIG. 27 shows a method to dynamically change the performance level in latency of a random access memory in a secondary tier memory of a host processor according to one embodiment. For example, the method of FIG. 27 can be implemented in the memory managers 113 of the computing system 100 of FIG. 1 to adjust the random access memory 112 using dynamic capacity devices offered by a compute express link fabric controller 122 and/or switch 220 as in FIG. 2 to FIG. 5 and FIG. 9 to FIG. 14. For example, the adjustments can be implemented using the techniques of FIG. 19, FIG. 20, and/or FIG. 21.

For example, the computing system 100 can include: a compute express link fabric 121 (e.g., as in FIG. 5) having a controller 122; a plurality of memory devices 141, 143, . . . , 145 connected to the compute express link fabric 121; and a plurality of host processors (e.g., devices 118, 128, 129) connected to the compute express link fabric 121. The controller is configured to, responsive to a request (e.g., 265) from a host processor 106, among the plurality of host processors (e.g., devices 118, 128, 129) and having a logical memory device 241 attached to via the compute express link fabric 121, change implementation of the logical memory device 241 implemented using memory resources of the memory devices 141, 143, . . . , 145. The change can be made without restarting the computing system 100, the host processor 106, and/or the compute express link fabric 121. The logical memory device 241 can have, before the request 265, a first level (e.g., 228 or 229) of latency in servicing the host processor 106 and, after the request 265, a second level (e.g., 229 or 228), different from the first level (e.g., 228 or 229), of latency in servicing the host processor 106. Thus, the request 265 can increase 247 or decrease 248 of the latency of the logical memory device 241 in servicing the host processor 106 over the compute express link fabric 121. For example, a memory manager 113 can be configured in the fabric 121, the controller 122, and/or the host system 102 to perform the method of FIG. 27.

At block 361, the method of FIG. 27 includes implementing, by a compute express link fabric 121 (e.g., as in FIG. 5), a logical memory device 241, attached to a host processor 106 over the fabric 121 (e.g., as in FIG. 14), using memory resources of a plurality of memory devices 141, 143, . . . , 145 connected to the compute express link fabric 121.

At block 363, the method includes routing, by the compute express link fabric 121, first memory access requests (e.g., 211), received from the host processor 106 and having memory addresses (e.g., 213) in the logical memory device (e.g., 241), to the memory devices 141, 143, . . . , 145 connected to the compute express link fabric 121 to provide memory access responses to the host processor 106 at a first latency level (e.g., 228 or 229).

At block 365, the method includes receiving, in the compute express link fabric 121 and from the host processor 106, a first request (e.g., 265) identifying a second latency level (e.g., 229 or 228).

For example, the first request 265 can be configured to identify a nominal latency level specified by the host processor 106 for the logical memory device 241. Optionally, the first request 265 can further specify a nominal bandwidth level for the logical memory device 241 to service the host processor 106, a nominal power efficiency level of the logical memory device 241, or a capacity size of the logical memory device 241, or any combination thereof.

For example, the second latency level (e.g., 229 or 228) can be the nominal latency level specified by the host processor 106 for the logical memory device 241 in the first request 265.

At block 367, the method includes adjusting, by the compute express link fabric 121 in responses to the first request (e.g., 265), implementation of the logical memory device 241 implemented using memory resources of the memory devices 141, 143, . . . , 145, such as portions 251, 253, 255 of random access memory cells 114 in the memory devices 141, 143, . . . , 145.

At block 369, the method includes routing, by the compute express link fabric 121 after the adjusting at block 367, second memory access requests (e.g., 211), received from the host processor 106 and having the memory addresses (e.g., 213) in the logical memory device 241, to the memory devices 141, 143, . . . , 145 connected to the compute express link fabric 121 to provide memory access responses to the host processor 106 at the second latency level (e.g., 229 or 228) that is different from the first latency level (e.g., 228 or 229).

Optionally, the method of FIG. 27 can further include, after the first request, the host processor 106 sending a second request to further change some aspects of the logical memory device 241 without restarting.

For example, the adjusting at block 367 can include updating a mapping 165 between the memory addresses (e.g., 213) in the logical memory device (e.g., 241) and memory addresses (e.g., 195) of memory resources (e.g., random access memory cells 114) allocated from the memory devices 141, 143, . . . , 145 to implement the logical memory device 241.

Optionally, the adjusting at block 367 can further include changing priorities of communications through the compute express link fabric 121 for accessing the logical memory device 241 relative to other communications.

For example, the updating of the mapping 165 includes changing a mapping destination of a region (e.g., portion 254) of the logical memory device 241 from a first memory device 141 to a second memory device 143 different from the first memory device 141, where the first memory device 141 and the second memory device 143 are configured to have different levels of latency in servicing the host processor 106 over the compute express link fabric 121.

To facilitate remapping the mapping destination of the portion 254 of the logical memory device 241 without impacting the ability of the host processor 106 in accessing the data of the portion 254, the controller 122 can perform autonomously copying of data of the portion 254 of the logical memory device 241 from the first memory device 141 to the second memory device 143 without assistance from the host processor 106.

In some implementations, the first memory device 141 and the second memory device 143 are manufactured to have a first communication interface and a second communication interface respectively and to have a same level of latency in providing memory access responses at the first communication interface and the second communication interface respectively.

For example, the first memory device 141 is connected to a first port of a compute express link switch 221; and the second memory device 143 is connected to a second port of the compute express link switch 221. Different priorities in routing the communications for the first port and the second port of the switch 221 can result in different latency levels of the first memory device 141 and the second memory device 143 in servicing the host processor 106.

Alternatively, the first memory device 141 is connected to a first port of a first compute express link switch 221 having a second port connected to a second compute express link switch 223; and the second memory device 143 is connected to the second compute express link switch 223. The communication delay over the second compute express link switch 223 can increase the latency level of the second memory device 143 in servicing the host processor 106.

In some implementations, the first memory device 141 is connected to a first port of a compute express link switch 221; the second memory device 143 is connected to a second port of the compute express link switch 221; and the first memory device 141 and the second memory device 143 are manufactured to have a first communication interface and a second communication interface respectively and to have different levels of latency in providing memory access responses at the first communication interface and the second communication interface respectively. Thus, the first memory device 141 and the second memory device 143 can have different latency levels in servicing the host processor 106, even though the communication delay through the fabric 121 to the host processor 106 can be the same for the first memory device 141 and the second memory device 143.

Optionally, the adjusting at block 367 is configured to not only change the latency of the logical memory device 241 in servicing the host processor 106, but also the capacity, bandwidth, and/or power efficiency of the logical memory device 241 according to the requirements provided by the host processor 106 in the first request 265. The method of FIG. 27 can be used in combination with the methods of FIG. 24 to FIG. 26, and/or FIG. 28.

FIG. 28 shows a method to dynamically change the performance level in power consumption of a random access memory in a secondary tier memory of a host processor according to one embodiment. For example, the method of FIG. 28 can be implemented in the memory managers 113 of the computing system 100 of FIG. 1 to adjust the random access memory 112 using dynamic capacity devices offered by a compute express link fabric controller 122 and/or switch 220 as in FIG. 2 to FIG. 5 and FIG. 9 to FIG. 14. For example, the adjustments can be implemented using the techniques of FIG. 22 and/or FIG. 23.

For example, the computing system 100 can include: a compute express link fabric 121 (e.g., as in FIG. 5) having a controller 122; a plurality of memory devices 141, 143, . . . , 145 connected to the compute express link fabric 121; and a plurality of host processors (e.g., devices 118, 128, 129) connected to the compute express link fabric 121. The controller is configured to receive a request (e.g., 265) identifying a power efficiency level (e.g., 238 or 239) of a logical memory device 241 attached to a host processor 106, among the host processors (e.g., devices 118, 128, 129), and to customize, based on the power efficiency level (e.g., 238 or 239) and in response to the request (e.g., 265), operations of the compute express link fabric 121 in routing memory access requests (e.g., 211) having memory addresses (e.g., 213) in the logical memory device 241 to the memory devices 141, 143, . . . , 145. For example, a memory manager 113 can be configured in the fabric 121, the controller 122, and/or the host system 102 to perform the method of FIG. 28.

At block 381, the method of FIG. 28 includes receiving, in a compute express link fabric 121 (e.g., as in FIG. 5), a request 265 identifying a power efficiency level (e.g., 238 or 239) of a logical memory device 241 attached to a host processor 106 (e.g., as in FIG. 14).

At block 383, the method includes configuring, based on the power efficiency level (e.g., 238 or 239) and in response to the request 265 without restarting, operations of the compute express link fabric 121 in routing memory access requests (e.g., 211) having memory addresses (e.g., 213) in the logical memory device 241.

At block 385, the method includes receiving, in the compute express link fabric 121 after the configuring at block 383, the memory access requests (e.g., 211).

At block 387, the method includes determining, by the compute express link fabric 121, memory resources in a plurality of memory devices 141, 143, . . . , 145 connected to the compute express link fabric 121.

At block 389, the method includes routing the memory access requests (e.g., 211) through the compute express link fabric 121 to the memory devices to access the memory resources, such as random access memory cells 114 at physical memory addresses (e.g., 195) in the memory devices 141, 143, . . . , 145.

For example, the configuring at block 383 can include changing a mapping 165 between the memory addresses (e.g., 213) and the memory resources, such as random access memory cells 114 at physical memory addresses (e.g., 195) in the memory devices 141, 143, . . . , 145.

For example, the memory devices 141, 143, . . . , 145 can include a first memory device 141 and a second memory device 145 having difference power efficiency levels; and the mapping 165 can be changed to move a mapping destination of a region of the memory addresses (e.g., a portion 254 of the logical memory device 241) between the first memory device 141 and the second memory device 145.

For example, the compute express link fabric 121 can be configured to change the mapping destination between the first memory device 141 and the second memory device 145 periodically to implement the power efficiency level identified in the request 265.

For example, the method of FIG. 28 can further include: determining a cycle ratio 273 between a time period (e.g., cycle 281) in which the mapping destination is mapped to the first memory device 141 and a time period (e.g., cycle 283) in which the mapping destination is mapped to the second memory device 145. The compute express link fabric 121 can be configured to change, according to the cycle ratio 273, the mapping destination between the first memory device 141 and the second memory device 145 periodically.

Optionally, the request 265 can further identify a capacity size (e.g., 215 or 216) of the logical memory device 241; and the mapping 165 can be changed to implement a change from a current size to the capacity size (e.g., 215 or 216) without restarting the computing system 100, the host processor 106, and/or the host system 102. For example, the method of FIG. 28 can be used in combination with the method of FIG. 24 and/or FIG. 25 to increase 243 or decrease 244 the capacity of the logical memory device 241, and/or to increase 271 or decrease 272 the power efficiency level of the logical memory device 241 according to a performance target 158 specified in the request 265.

Optionally, the request 265 can further identify a bandwidth level (e.g., 218, or 219) of the logical memory device 241; and the mapping 165 can be further changed to implement a change from a current bandwidth to the bandwidth level (e.g., 218, or 219) of the logical memory device 241 in servicing the host processor 106 without restarting the computing system 100, the host processor 106, and/or the host system 102. For example, the method of FIG. 28 can be used in combination with the method of FIG. 24, FIG. 25, and/or FIG. 26 to increase 243 or decrease 244 the capacity of the logical memory device 241, to increase 245 or decrease 246 the bandwidth of the logical memory device 241 in servicing the host processor 106, and/or to increase 271 or decrease 272 the power efficiency level of the logical memory device 241 according to a performance target 158 specified in the request 265.

Optionally, the request 265 can further identify a latency level (e.g., 228 or 229) of the logical memory device 241; and the mapping 165 can be further changed to implement a change from a current latency to the latency level (e.g., 228 or 229) of the logical memory device 241 in servicing the host processor 106 without restarting the computing system 100, the host processor 106, and/or the host system 102. For example, the method of FIG. 28 can be used in combination with the method of FIG. 24, FIG. 25, FIG. 26, and/or FIG. 27 to increase 243 or decrease 244 the capacity of the logical memory device 241, to increase 245 or decrease 246 the bandwidth of the logical memory device 241 in servicing the host processor 106, to increase 247 or decrease 248 the latency of the logical memory device 241 in servicing the host processor 106, and/or to increase 271 or decrease 272 the power efficiency level of the logical memory device 241 according to a performance target 158 specified in the request 265.

A non-transitory computer storage medium can be used to store instructions programmed to implement a memory manager 113 configured to perform operations discussed above in connection with the random access memory 112 in a secondary tier memory of a host processor 106. When the instructions are executed by the processing device 118, the controller 115, the processing device 117, the controller 122, and/or the compute express link switches (e.g., 220; 221, 223, . . . , 225), the instructions cause the compute express link fabric 121, its controller 115 and/or the compute express link switches (e.g., 220; 221, 223, . . . , 225) in the fabric 121 to perform the methods discussed above.

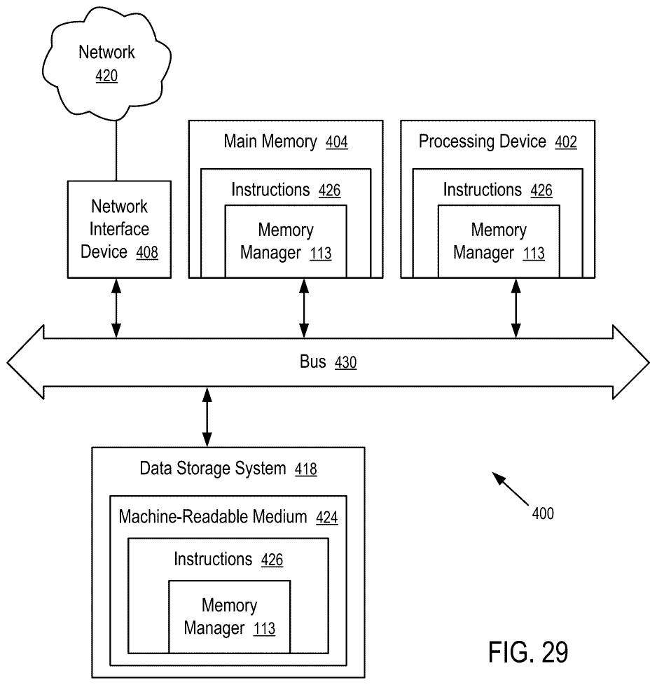

FIG. 29 illustrates an example machine of a computer system 400 within which a set of instructions, for causing the machine to perform any one or more of the methodologies discussed herein, can be executed. In some embodiments, the computer system 400 can correspond to a host system (e.g., the host system 102 of FIG. 1) that includes, is coupled to, or utilizes a memory sub-system (e.g., the memory sub-system 101 of FIG. 1) or can be used to perform the operations of memory managers 113 (e.g., to execute instructions to perform operations corresponding to the memory managers 113 described with reference to FIGS. 1-28) . In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a personal digital assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 400 includes a processing device 402, a main memory 404 (e.g., read-only memory (ROM), flash memory, dynamic random access memory (DRAM) such as synchronous DRAM (SDRAM) or Rambus DRAM (RDRAM), static random access memory (SRAM), etc.), and a data storage system 418, which communicate with each other via a bus 430 (which can include multiple buses).

Processing device 402 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 402 can also be one or more special-purpose processing devices such as an application specific integrated circuit (ASIC), a field programmable gate array (FPGA), a digital signal processor (DSP), network processor, or the like. The processing device 402 is configured to execute instructions 426 for performing the operations and steps discussed herein. The computer system 400 can further include a network interface device 408 to communicate over the network 420.

The data storage system 418 can include a machine-readable medium 424 (also known as a computer-readable medium) on which is stored one or more sets of instructions 426 or software embodying any one or more of the methodologies or functions described herein. The instructions 426 can also reside, completely or at least partially, within the main memory 404 and/or within the processing device 402 during execution thereof by the computer system 400, the main memory 404 and the processing device 402 also constituting machine-readable storage media. The machine-readable medium 424, data storage system 418, and/or main memory 404 can correspond to the memory sub-system 101 of FIG. 1.

In one embodiment, the instructions 426 include instructions to implement functionality corresponding to the memory managers 113 described with reference to FIGS. 1-28. While the machine-readable medium 424 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to convey the substance of their work most effectively to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In this description, various functions and operations are described as being performed by or caused by computer instructions to simplify description. However, those skilled in the art will recognize what is meant by such expressions is that the functions result from execution of the computer instructions by one or more controllers or processors, such as a microprocessor. Alternatively, or in combination, the functions and operations can be implemented using special purpose circuitry, with or without software instructions, such as using application-specific integrated circuit (ASIC) or field-programmable gate array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

1. A method, comprising:
connecting a compute express link fabric to a plurality of memory devices and a host processor;
allocating, by the compute express link fabric, memory resources from the memory devices to implement a logical memory device attached to the host processor; and
maintaining, in the compute express link fabric, a mapping between memory addresses in the logical memory device and the memory resources to route memory access requests having the memory addresses to access the memory resources in the memory devices.

2. The method of claim 1, further comprising:
receiving, in the compute express link fabric, a request from the host processor to change a capacity size of the logical memory device attached to the host processor; and
adjusting, by the compute express link fabric in response to the request, the mapping to change the capacity size of the logical memory device without restarting a computing system containing the host processor;
wherein the request is communicated in accordance a standard for compute express link (CXL); and the logical memory device is attached to the host processor as a dynamic capacity device.

3. The method of claim 2, wherein the memory resources are allocated from more than one of the memory devices to implement the logical memory device.

4. The method of claim 3, further comprising:
receiving, in the compute express link fabric and from the host processor, a capacity query for the logical memory device prior to the request;
determining, by the compute express link fabric in response to the capacity query, an amount of memory resources in the memory devices that are currently available for allocation to the logical memory device; and
identifying, to the host processor by the compute express link fabric based on the amount and in response to the capacity query, a maximum available capacity of the logical memory device.

5. The method of claim 4, wherein the request from the host processor identifies a requested capacity size of the logical memory device that is no larger than the maximum available capacity.

6. The method of claim 5, wherein the requested capacity size is larger than a capacity size of the logical memory device at a time when the request is received in the compute express link fabric.

7. The method of claim 6, further comprising:
generating, by the compute express link fabric after completion of the adjusting, a response to the request.

8. The method of claim 3, wherein the request from the host processor identifies a requested capacity size of the logical memory device that is smaller than a capacity size of the logical memory device at a time when the request is received in the compute express link fabric.

9. A system, comprising:
a compute express link fabric having a controller;
a plurality of memory devices connected to the compute express link fabric; and
a plurality of host processors connected to the compute express link fabric;
wherein the controller is configured to attach, at a boot time of the system, a logical memory device to a host processor among the plurality of host processors; and
wherein the controller is further configured to allocate memory resources from the memory devices to implement the logical memory device using a mapping between memory addresses in the logical memory device and the memory resources to route memory access requests having the memory addresses to access the memory resources in the memory devices.

10. The system of claim 9, wherein the controller is further configured to receive a request from the host processor to change a capacity size of the logical memory device attached to the host processor and, in response to the request, adjust the mapping to change the capacity size of the logical memory device without restarting the system;
wherein the compute express link fabric further includes a plurality of compute express link switches; and
wherein the memory resources are allocated from more than one of the memory devices to implement the logical memory device.

11. The system of claim 10, wherein the request is communicated in accordance a standard for compute express link (CXL); and the logical memory device is attached to the host processor as a dynamic capacity device.

12. The system of claim 11, wherein the controller is further configured to:
receive, from the host processor and prior to the request, a capacity query for the logical memory device;
determine, responsive to the capacity query, an amount of memory resources in the memory devices that are currently available for allocation to the logical memory device; and
identify, to the host processor based on the amount and in response to the capacity query, a maximum available capacity of the logical memory device.

13. The system of claim 12, wherein the request from the host processor identifies a requested capacity size of the logical memory device that is no larger than the maximum available capacity.

14. The system of claim 13, wherein the requested capacity size is larger than a capacity size of the logical memory device at a time when the request is received in the compute express link fabric.

15. The system of claim 14, wherein the controller is further configured to generate, after completion of adjusting the mapping in response to the request, a response to the request.

16. The system of claim 11, wherein the request from the host processor identifies a requested capacity size of the logical memory device that is smaller than a capacity size of the logical memory device at a time when the request is received in the compute express link fabric.

17. A non-transitory computer storage medium storing instructions which, when executed by a controller of a compute express link fabric, cause the controller to perform a method, comprising:
allocating memory resources from a plurality of memory devices connected to the compute express link fabric to implement a logical memory device attached, at a boot time, to a host processor connected to the compute express link fabric; and
causing the compute express link fabric to route, according to a mapping between memory addresses in the logical memory device and the memory resources, memory access requests having the memory addresses to access the memory resources in the memory devices.

18. The non-transitory computer storage medium of claim 17, wherein the method further comprises:
receiving a request from the host processor to change a capacity size of the logical memory device attached to the host processor; and
adjusting, in response to the request, the mapping to change the capacity size of the logical memory device without restarting;
wherein the compute express link fabric includes a plurality of compute express link switches; and
wherein the memory resources are allocated from more than one of the memory devices to implement the logical memory device.

19. The non-transitory computer storage medium of claim 18, wherein the method further comprises:
receiving, from the host processor, a capacity query for the logical memory device prior to the request;
determining, responsive to the capacity query, an amount of memory resources in the memory devices that are currently available for allocation to the logical memory device; and
identifying, to the host processor based on the amount and in response to the capacity query, a maximum available capacity of the logical memory device.

20. The non-transitory computer storage medium of claim 19, wherein the method further comprises:
generating, after completion of the adjusting of the mapping, a response to the request.
